(19) United States
(12) Patent Application Publication
(10) Pub. No.: US 2024/0264974 A1
(43) Pub. Date: Aug. 8, 2024

(54) PARALLEL PROCESSING HAZARD MITIGATION AVOIDANCE

(71) Applicant: Ascenium, Inc., Mountain View, CA (US)

(72) Inventor: Peter Foley, Los Altos Hills, CA (US)

(73) Assignee: Ascenium, Inc., Mountain View, CA (US)

(21) Appl. No.: 18/640,044

(22) Filed: Apr. 19, 2024

Related U.S. Application Data
(63) Continuation-in-part of application No. 17/526,003, filed on Nov. 15, 2021.
Application No. 17/526,003 is a continuation-in-part of application No. 17/465,949, filed on Sep. 3, 2021.
(60) Provisional application No. 63/536,144, filed on Sep. 1, 2023.
(60) Provisional application No. 63/529,159, filed on Jul. 27, 2023.
(60) Provisional application No. 63/460,909, filed on Apr. 21, 2023.
(60) Provisional application No. 63/254,557, filed on Oct. 12, 2021.
(60) Provisional application No. 63/232,230, filed on Aug. 12, 2021.
(60) Provisional application No. 63/229,466, filed on Aug. 4, 2021.
(60) Provisional application No. 63/193,522, filed on May 26, 2021.
(60) Provisional application No. 63/166,298, filed on Mar. 26, 2021.
(60) Provisional application No. 63/125,994, filed on Dec. 16, 2020.
(60) Provisional application No. 63/114,003, filed on Nov. 16, 2020.
(60) Provisional application No. 63/091,947, filed on Oct. 15, 2020.
(60) Provisional application No. 63/075,849, filed on Sep. 9, 2020.

(51) Int. Cl. G06F 15/80; G06F 12/0895

(52) U.S. Cl. CPC G06F 15/8007; G06F 12/0895

(57) ABSTRACT

Techniques for parallel processing based on hazard mitigation avoidance are disclosed. An array of compute elements is accessed. Each compute element within the array is known to a compiler and is coupled to its neighboring compute elements within the array of compute elements. Control for the compute elements is provided on a cycle-by-cycle basis. Control is enabled by a stream of wide control words generated by the compiler. Memory access operation hazard mitigation is enabled. The hazard mitigation is enabled by a control word tag. The control word tag supports memory access precedence information and is provided by the compiler at compile time. A hazardless memory access operation is executed. The hazardless memory access operation is determined by the compiler, and the hazardless memory access operation is designated by a unique set of precedence information contained in the tag. The tag is modified during runtime by hardware.

### RELATED APPLICATIONS

This application claims the benefit of U.S. provisional patent applications “Parallel Processing Hazard Mitigation Avoidance” Ser. No. 63/460,909, filed Apr. 21, 2023, “Parallel Processing Architecture With Block Move Support” Ser. No. 63/529,159, filed Jul. 27, 2023, and “Parallel Processing Architecture With Block Move Backpressure” Ser. No. 63/536,144, filed Sep. 1, 2023.

This application is also a continuation-in-part of U.S. patent application “Highly Parallel Processing Architecture With Compiler” Ser. No. 17/526,003, filed Nov. 15, 2021, which claims the benefit of U.S. provisional patent applications “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array” Ser. No. 63/193,522, filed May 26, 2021, “Parallel Processing Architecture For Atomic Operations” Ser. No. 63/229,466, filed Aug. 4, 2021, “Parallel Processing Architecture With Distributed Register Files” Ser. No. 63/232,230, filed Aug. 12, 2021, and “Load Latency Amelioration Using Bunch Buffers” Ser. No. 63/254,557, filed Oct. 12, 2021.

The U.S. patent application “Highly Parallel Processing Architecture With Compiler” Ser. No. 17/526,003, filed Nov. 15, 2021 is also a continuation-in-part of U.S. patent application “Highly Parallel Processing Architecture With Shallow Pipeline” Ser. No. 17/465,949, filed Sep. 3, 2021, which claims the benefit of U.S. provisional patent applications “Highly Parallel Processing Architecture With Shallow Pipeline” Ser. No. 63/075,849, filed Sep. 9, 2020, “Parallel Processing Architecture With Background Loads” Ser. No. 63/091,947, filed Oct. 15, 2020, “Highly Parallel Processing Architecture With Compiler” Ser. No. 63/114,003, filed Nov. 16, 2020, “Highly Parallel Processing Architecture Using Dual Branch Execution” Ser. No. 63/125,994, filed Dec. 16, 2020, “Parallel Processing Architecture Using Speculative Encoding” Ser. No. 63/166,298, filed Mar. 26, 2021, “Distributed Renaming Within A Statically Scheduled Array” Ser. No. 63/193,522, filed May 26, 2021, Parallel Processing Architecture For Atomic Operations” Ser. No. 63/229,466, filed Aug. 4, 2021, and “Parallel Processing Architecture With Distributed Register Files” Ser. No. 63/232,230, filed Aug. 12, 2021.

Each of the foregoing applications is hereby incorporated by reference in its entirety.

### FIELD OF ART

This application relates generally to parallel processing and more particularly to parallel processing hazard mitigation avoidance.

### BACKGROUND

Data is among the most valuable assets of any organization. Organizations process immense and often unstructured datasets to achieve their organizational missions and purposes. The purposes include commercial, educational, governmental, medical, research, or retail purposes, to name only a few. The datasets can be analyzed for forensic and law enforcement purposes. Computational resources are used by the organizations to meet organizational needs. The organizations range in size from sole proprietor operations to large, international organizations. The computational resources include processors, data storage units, networking and communications equipment, telephony, power conditioning units, HVAC equipment, and backup power units, among other essential equipment. Energy resource management is also critical since the computational resources consume vast amounts of energy and produce copious heat. The computational resources can be housed in special-purpose installations that are frequently high security. These installations more closely resemble high-security bases or even vaults than traditional office buildings. Not every organization requires vast computational equipment installations, but all strive to provide resources to meet their data processing needs as quickly and cost effectively as possible.

The organizations execute a wide variety of processing jobs. The processing jobs include running billing and payroll, generating profit and loss statements, processing tax returns or election results, controlling experiments, analyzing research data, and generating academic grades, among others. The processing jobs consume computational resources in installations that typically operate 24×7×365. The types of data processed derive from the organizational missions. These processing jobs must be executed quickly, accurately, and cost-effectively. The processed datasets can be very large and unstructured, thereby saturating conventional computational resources. Processing an entire dataset may be required to find a particular data element. Effective dataset processing enables rapid and accurate identification of potential customers, or finetuning production and distribution systems, among other results that yield a competitive advantage to the organization. Ineffective processing wastes money by losing sales or failing to streamline a process, thereby increasing costs.

Organizations accumulate their data by implementing various data collection techniques. The data is collected from various and diverse categories of individuals. Legitimate data collection techniques include “opt-in” strategies, where an individual signs up, creates an account, registers, or otherwise actively and willingly agrees to participate in the data collection. Some techniques are legislative, where citizens are required by a government to obtain a registration number to interact with government agencies, law enforcement, emergency services, and others. At other times, the individuals are unwitting subjects of data collection. Still other data collection techniques are more subtle or are even completely hidden, such as tracking purchase histories, visits to various websites, button clicks, and menu choices. Data can and has been collected by theft. Irrespective of the techniques used for the data collection, the collected data is highly valuable to the organizations if processed rapidly and accurately.

### SUMMARY

To improve task processing efficiency and data throughput, the tasks and subtasks can be processed using arrays of elements. The arrays include compute elements; multicycle elements for multiplication, division, and square root computations; registers; caches; queues; register files; buffers; controllers; decompressors; arithmetic logic units (ALUs); storage elements, scratchpads; and other components. The components can communicate among themselves to exchange instructions, data, signals, and so on. These arrays of elements are configured and operated by providing control to the array of elements on a cycle-by-cycle basis. The control of the array is accomplished by providing control words generated by a compiler. The control includes a stream of control words, where the control words can include wide microcode control words generated by the compiler. The wide control words can comprise variable length control words. The variable length can be a result of a run-length type encoding technique, which can exclude, for example, information for array resources that are not used. Each control word can include, at the start of the control word, an offset to the next control word, which makes this type of variable length encoding efficient from a fetch and decompress pipeline standpoint.

Memory access operation hazard mitigation is enabled. The hazard mitigation can mitigate hazards such as write-after-read, read-after-write, and write-after-write conflicts. The hazard mitigation is enabled by a control word tag. The control tag, which can include a fixed length tag or a variable length tag, can be included within the control word, associated with the control word, and so on. The control word tag supports memory access precedence information. The supported memory access precedence information can include a memory operation number, an elapsed cycle return count, and so on. The control memory access precedence information is provided by the compiler at compile time. A hazardless memory access operation is executed. The hazardless memory access operation can include a memory access load operation or a memory access store operation. The hazardless memory access operation is determined by the compiler. The compiler can determine the hazardless memory access operation as compile time. The hazardless memory access operation is designated by a unique set of precedence information contained in the tag. The unique set of precedence information is contained in the tag. The unique tag can indicate a safe/unsafe memory access. A safe memory access can include loads from a data cache, a constant, or a read probe. A safe memory access can further include a safe store to a data cache, a single compute element operation, or a store probe.

A processor-implemented method for parallel processing is disclosed comprising: accessing an array of compute elements, wherein each compute element within the array of compute elements is known to a compiler and is coupled to its neighboring compute elements within the array of compute elements; providing control for the compute elements on a cycle-by-cycle basis, wherein control is enabled by a stream of wide control words generated by the compiler; enabling memory access operation hazard mitigation, wherein the hazard mitigation is enabled by a control word tag, wherein the control word tag supports memory access precedence information and is provided by the compiler at compile time; and executing a hazardless memory access operation, wherein the hazardless memory access operation is determined by the compiler, and wherein the hazardless memory access operation is designated by a unique set of precedence information contained in the tag. Further embodiments include modifying the tag during runtime. In embodiments, the modifying is performed by hardware. The hardware modifying is based on a change of memory access hazards. In embodiments, the change of memory access hazards results from a branch operation decision. In other embodiments, the change of memory access hazards results from a long access data load. The long access data load comprises a memory access from dynamic random-access memory (DRAM). The long access data load comprises a memory access from non-volatile storage. The non-volatile storage comprises NAND flash storage.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for parallel processing hazard mitigation avoidance.

FIG. 2 is a flow diagram for control word tag usage.

FIG. 3 is a system block diagram showing compiler-provided tag and hardware updating.

FIG. 4 illustrates a system block diagram for a highly parallel architecture with a shallow pipeline.

FIG. 5 shows compute element array detail.

FIG. 6 is a system block diagram for compiler interactions.

FIG. 7 shows a control word with load operations.

FIG. 8 illustrates a control word with a store operation.

FIG. 9 shows branch handling for hazard mitigation avoidance.

FIG. 10 is a system diagram for parallel processing hazard mitigation avoidance.

### DETAILED DESCRIPTION

Organizations process immense, varied, and at times unstructured datasets to support a wide variety of organizational missions and purposes. The purposes include commercial, educational, governmental, medical, research, or retail purposes, to name only a few. The datasets can also be analyzed for forensic and law enforcement purposes. Computational resources are obtained and implemented by the organizations to meet organizational needs. The organizations range in size from sole proprietor operations to large, international organizations. The computational resources include processors, data storage units, networking and communications equipment, telephony, power conditioning units, HVAC equipment, and backup power units, among other essential equipment. Energy resource management is also critical since the computational resources consume vast amounts of energy and produce copious heat. The computational resources can be housed in special-purpose, and frequently high security, installations. These installations more closely resemble high-security bases or even vaults than traditional office buildings. Not every organization requires vast computational equipment installations, but all strive to provide resources to meet their data processing needs as quickly and cost effectively as possible.

Techniques for parallel processing hazard mitigation avoidance are disclosed. In an architecture, such as an architecture based on configurable compute elements as described herein, the loading of data, control words, compute element operations, and so on can cause execution of a process, task, subtask, and the like to stall operations in the array. The stalling can occur when data, required by an operation executing on a compute element, is late or otherwise unavailable. Loading data can be further complicated when the operation includes a branch operation. In order to speed execution, memory access requests associated with two or more sides of the branch operation can be generated so that each side of the branch can begin execution in parallel prior to the branch decision being determined. Once the branch decision is made, execution of the taken side of the branch can proceed while all other sides of the branch are halted. However, memory access operations can remain in process at the point at which the branch decision is made. Memory access operations associated with untaken sides can be terminated. Since each memory access operation consumes some computational resources, such as access to a bus, crossbar switch, cache memory, memory system, etc., memory access latency is affected.

Execution of memory access operations can be implemented by enabling memory access hazard mitigation. The memory hazard mitigation can ensure that valid data is available in time for processing, that valid data is not overwritten before it can be loaded or stored, and so on. The memory access hazard mitigation is accomplished by using a control word tag, where a control word tag can be associated with a control word. The control word and the associated control word tag can be provided by a compiler at compile time. The control word tag can include a memory operation number, an elapsed cycle return count, and so on. The control word tag can further include a unique set of precedence information. The unique set of precedence information can indicate an order of operations execution, can support multiple control word memory accesses, and the like. The multiple control word memory accesses which can be designated as a safe or unsafe memory access can include loads from a data cache, loading one or more constant values, etc. A safe load can include a read probe to find data in a cache, a multi-level cache, a memory system, and so on.

Stalling can cause execution of a single compute element to halt or suspend, which requires the entire array to stall. The stalling occurs because the hardware must be kept in synchronization with compiler expectations on an architectural cycle basis, described later. The halting or suspending can continue while needed data is stored or fetched or completes operation. The compute element array as a whole stalls if external memory cannot supply data in time or if a new control word cannot be fetched and/or decompressed in time, for example. In addition, a multicycle, nondeterministic duration operation in a multicycle element (MEM), such as a divide operation, may take longer than scheduled to complete, in which case the compute element array would stall while waiting for the MEM operation to complete (when that result is to be taken into the array as an operand). Noted throughout, control for the array of compute elements is provided on a cycle-by-cycle basis. The control can be based on one or more sets of control words. The control words can include short words, long words, and so on. The control that is provided to the array of compute elements is enabled by a stream of wide control words generated by a compiler. The control words can be of variable length. The compiler can include a general-purpose compiler, a hardware description compiler, a specialized compiler, etc. The control words comprise compute element operations. The control words can be of variable length, as described by the architecture, or they can be of a fixed length. However, a fixed length control word can be compressed, which can result in variable lengths for operational usage to save space. At least two operations that can be contained in one or more control words can be loaded into buffers. The buffers can include autonomous operation buffers. The control words can include control word bunches, which can provide operational control of a particular compute element. The control words can be loaded into an autonomous operation buffer. Additional autonomous operation buffers can be loaded with additional operations contained in the one or more control words. The autonomous operation buffer and the additional autonomous operation buffers can be integrated into one or more compute elements. The control word bits provide operational control for the compute element. In addition to providing control to the compute elements within the array, data can be transferred or “preloaded” into caches, registers, and so on prior to executing the tasks or subtasks that process the data.

Sides of a branch operation can be executed in parallel while a branch decision is being made. The executing is accomplished by mapping a plurality of compute elements within the array of compute elements. The mapping is determined by a compiler at compile time. The mapping the compute elements can include configuring and scheduling the compute elements to execute operations associated with the sides of the branch. The mapping distributes parallelized operations to the plurality of compute elements. The distributed parallelized operations can enable the parallel execution of the sides of the branch operation. The mapping, including a column of compute elements within the plurality of compute elements, is enabled to perform vertical data access suppression, and a row of compute elements is enabled to perform horizontal data access suppression. The data access suppression can prevent data accesses from being executed and can prevent the data accesses from leaving the array of compute elements. The branch decision determines which branch path or branch side to take based on evaluating an expression. The expression can include a logical expression, a mathematical expression, and so on. When the branch decision is determined, the selected branch side can continue executing while other sides of the branch can be suspended, halted, and the like. Since the operations associated with each side of the branch can include data access operations, data access operations associated with each side can be pending when the branch decision is determined or made. Data access operations associated with the untaken branch sides can be suppressed. The data access suppressing can be based on the branch decision and an invalid indication. The invalid indication can be based on a bit, a flag, a semaphore, a signal, etc.

Buffers for storing control words can be based on storage elements, registers, etc. The registers can be based on a memory element with two read ports and one write port (2R1W). The 2R1W memory element enables two read operations and one write operation to occur substantially simultaneously. A plurality of buffers based on a 2R1W register can be distributed throughout the array. The control words can be written to one or more buffers associated with each compute element within the 2D array of compute elements. The control words can configure the compute elements, enable the compute elements to execute operations autonomously within the array, and so on. The control words can include a number of operations that can accomplish some or all of the operations associated with a task, a subtask, and so on. Two or more compute element operations contained in one or more control words can be loaded into an autonomous operation buffer. The compute element operations or additional compute element operations can be loaded into additional autonomous operation buffers. By providing a sufficient number of operations into the operation buffer, autonomous operation of the compute element can be accomplished. The autonomous operation of the compute element can be based on the compute element operation counter keeping track of cycling through the autonomous operation buffer. The keeping track of cycling through the autonomous operation buffer is enabled without additional control word loading into the buffers. Recall that latency associated with access by a compute element to storage, that is, memory external to a compute element or to the array of compute elements, can be significant and can cause the compute element array to stall. By performing operations without additional loading of control words, control word load latency can be eliminated, thus expediting the execution of operations.

Tasks and subtasks that are executed by the compute elements within the array of compute elements can be associated with a wide range of applications. The applications can be based on data manipulation, such as image, video, or audio processing applications; AI applications; business applications; data processing and analysis; and so on. The tasks that are executed can perform a variety of operations including arithmetic operations, shift operations, logical operations including Boolean operations, vector or matrix operations, tensor operations, and the like. The subtasks can be executed based on precedence, priority, coding order, amount of parallelization, data flow, data availability, compute element availability, communication channel availability, and so on.

The data manipulations are performed on an array of compute elements (CEs). The compute elements within the array can be implemented with central processing units (CPUs), graphics processing units (GPUs), application specific integrated circuits (ASICs), field programmable gate arrays (FPGAs), processing cores, or other processing components or combinations of processing components. The compute elements can include heterogeneous processors, homogeneous processors, processor cores within an integrated circuit or chip, etc. The compute elements can be coupled to local storage, which can include local memory elements, register files, cache storage, etc. The cache, which can include a hierarchical cache such as an L1, L2, and L3 cache, can be used for storing data such as intermediate results, compressed control words, coalesced control words, decompressed control words, compute element operations, relevant portions of a control word, and the like. The cache can store data produced by a taken branch path, where the taken branch path is determined by a branch decision. The decompressed control word is used to control one or more compute elements within the array of compute elements. Multiple layers of the two-dimensional (2D) array of compute elements can be “stacked” to comprise a three-dimensional array of compute elements.

The tasks, subtasks, etc., that are associated with processing operations are generated by a compiler. The compiler can include a general-purpose compiler, a hardware description-based compiler, a compiler written or “tuned” for the array of compute elements, a constraint-based compiler, a satisfiability-based compiler (SAT solver), and so on. Control is provided to the hardware in the form of control words, where one or more control words are generated by the compiler. The control words are provided to the array on a cycle-by-cycle basis. The control words can include wide, variable length, microcode control words. The length of a microcode control word can be adjusted by compressing the control word. The compressing can be accomplished by recognizing situations where a compute element is unneeded by a task. Thus, control bits within the control word associated with the unneeded compute elements are not required for that compute element. Bits within the control word can include a unique set of precedence information that can be used to execute hazardless memory access operations.

Various control word compression techniques can also be applied. The control words can be used to route data, to set up operations to be performed by the compute elements, to idle individual compute elements or rows and/or columns of compute elements, etc. Noting that the compiled microcode control words that are generated by the compiler are based on bits, the control words can be compressed by selecting bits from the control words. Compute element operations contained in one or more control words from a number of control words can be loaded into one or more autonomous operation buffers. The contents of the buffers provide control to the compute elements. The control of the compute elements can be accomplished by a control unit. Thus, in general, the hardware is completely under compiler control, which means that the hardware and the operation of the hardware-particularly the operation of any given compute element—are controlled on a cycle-by-cycle basis by compiler-generated control words driven into the array of compute elements by a control unit. However, local compute element autonomous operation can be enabled using buffers, which can be described as “bunch buffers”.

Autonomous compute element operation enables parallel processing. The parallel processing can include data manipulation. A two-dimensional (2D) array of compute elements is accessed. The compute elements can include compute elements, processors, or cores within an integrated circuit; processors or cores within an application specific integrated circuit (ASIC); cores programmed within a programmable device such as a field programmable gate array (FPGA); and so on. The compute elements can include homogeneous or heterogeneous processors. Each compute element within the 2D array of compute elements is known to a compiler. The compiler, which can include a general-purpose compiler, a hardware-oriented compiler, or a compiler specific to the compute elements, can compile code for each of the compute elements. Each compute element is coupled to its neighboring compute elements within the array of compute elements. The coupling of the compute elements enables data communication between and among compute elements. Thus, the compiler can control data flow between and among the compute elements and can further control data commitment to memory outside of the array.

Wide control words that are generated by a compiler are provided to the array. The wide control words are used to control elements within an array of compute elements on a cycle-by-cycle basis. A plurality of compute elements within the array of compute elements is initialized based on a control word from the stream of control words. The control that is provided by the wide control words includes a branch operation. The branch operation such as a conditional branch operation can include an expression and two or more paths or sides. The plurality of compute elements is mapped, where the mapping distributes parallelized operations to the plurality of compute elements. The parallelized operations enable parallel execution of the sides of the branch operation. The parallelized operations can include primitive operations that can be executed in parallel. A primitive operation can include an arithmetic operation, a logical operation, a data handling operation, and so on. The mapping in each element of the plurality of compute elements can include a spatially adjacent mapping. The spatial adjacency can include pairs and quads of compute elements, regions and quadrants of compute elements, and so on. The spatially adjacent mapping comprises an M×N subarray of the array of compute elements. The primitive operations associated with the branch operations can be mapped into some or all of the compute elements. Unmapped compute elements within the M×N array can be initialized for operations unassociated with the branch operation. The spatially adjacent mapping is determined at compile time by the compiler.

In order for tasks, subtasks, and so on to execute properly, particularly in a statically scheduled architecture such as an array of compute elements, one or more operations associated with the plurality of wide control words must be executed in a semantically correct operations order. That is, the data access load and store operations associated with sides of a branch operation and with other operations must occur in an order that supports the execution of the branch, tasks, subtasks, and so on. If the data access load and store operations do not occur in the proper order, then invalid data is loaded, stored, or processed. Another consequence of “out of order” memory access load and store operations is that the execution of the tasks, subtasks, etc., must be halted or suspended until valid data is available, thus increasing execution time. A valid indication can be associated with data access operations to enable hardware ordering of data access loads to the array of compute elements, and data access stores from the array of compute elements. Conversely, an invalid (e.g., not valid) indication associated with data access operations can suppress data access operations. The loads and stores can be controlled locally, in hardware, by one or more control elements associated with or within the array of compute elements. The controlling in hardware is accomplished without compiler involvement beyond the compiler providing the plurality of control words that include precedence information.

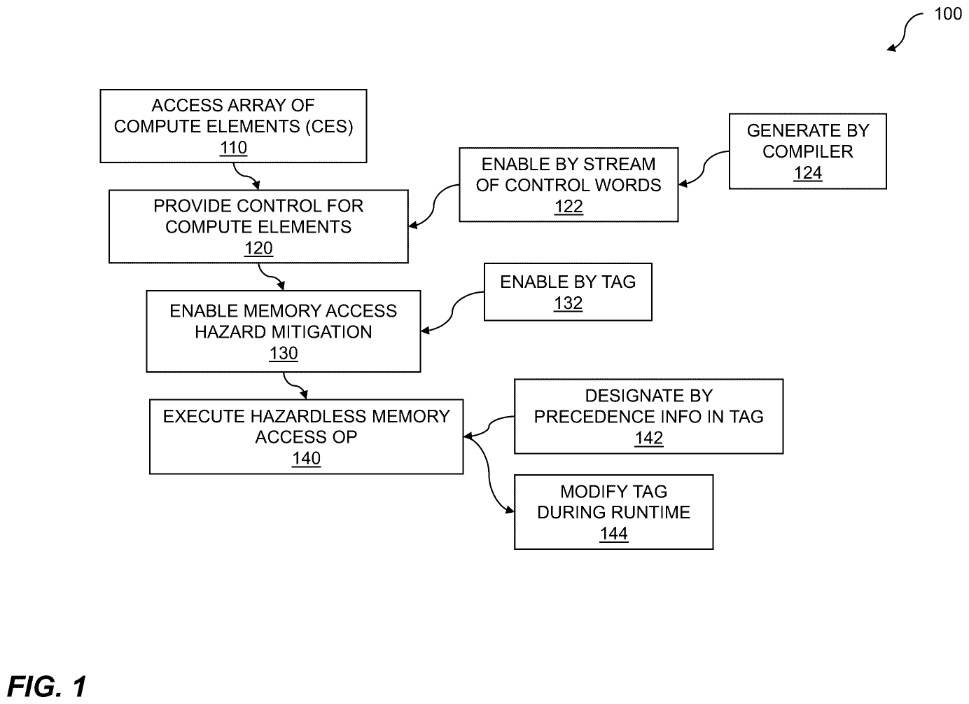

FIG. 1 is a flow diagram for parallel processing hazard mitigation avoidance. Groupings of compute elements (CEs), such as CEs assembled within a 2D array of CEs, can be configured to execute a variety of operations associated with data processing. The operations can be based on tasks and on subtasks, where the subtasks are associated with the tasks. The 2D array can further interface with other elements such as controllers, storage elements, ALUs, memory management units (MMUs), GPUs, multicycle elements (MEMs), and so on. The operations can accomplish a variety of processing objectives such as application processing, data manipulation, data analysis, modeling and simulation, and so on. The operations can manipulate a variety of data types including integer, real, and character data types; vectors, matrices, and arrays; tensors; etc. Control is provided to the array of compute elements on a cycle-by-cycle basis, where the control is enabled by a stream of wide control words generated by a compiler. The control words, which can include microcode control words, enable or idle various compute elements; provide data; route results between or among CEs, caches, scratchpads, and storage; and the like. The control enables compute element operation, memory access precedence, etc. Compute element operation and memory access precedence enable the hardware to properly sequence data provisioning and compute element results. The control enables execution of a compiled program on the array of compute elements.

The flow 100 includes accessing an array 110 of compute elements, wherein each compute element within the array of compute elements is known to a compiler and is coupled to its neighboring compute elements within the array of compute elements. The compute elements can be based on a variety of types of processors. The compute elements or CEs can include central processing units (CPUs), graphics processing units (GPUs), processors or processing cores within application specific integrated circuits (ASICs), processing cores programmed within field programmable gate arrays (FPGAs), and so on. In embodiments, compute elements within the array of compute elements have identical functionality. The compute elements can be arranged in pairs, quads, and so on, and can share resources within the arrangement. The compute elements can include heterogeneous compute resources, where the heterogeneous compute resources may or may not be colocated within a single integrated circuit or chip. The compute elements can be configured in a topology, where the topology can be built into the array, programmed or configured within the array, etc. In embodiments, the array of compute elements is configured by a control word that can implement a topology. The topology that can be implemented can include one or more of a systolic, a vector, a cyclic, a spatial, a streaming, or a Very Long Instruction Word (VLIW) topology. In embodiments, the array of compute elements can include a two-dimensional (2D) array of compute elements. More than one 2D array of compute elements can be accessed. Two or more arrays of compute elements can be colocated on an integrated circuit or chip, on multiple chips, and the like. In embodiments, two or more arrays of compute elements can be stacked to form a three-dimensional (3D) array. The stacking of the arrays of compute elements can be accomplished using a variety of techniques. In embodiments, the three-dimensional (3D) array can be physically stacked. The 3D array can comprise a 3D integrated circuit. In other embodiments, the three-dimensional array is logically stacked. The logical stacking can include configuring two or more arrays of compute elements to operate as if they were physically stacked.

The compute elements can further include a topology suited to machine learning computation. A topology for machine learning can include supervised learning, unsupervised learning, reinforcement learning, and other machine learning topologies. A topology for machine learning can include an artificial neural network topology. The compute elements can be coupled to other elements within the array of CEs. In embodiments, the coupling of the compute elements can enable one or more further topologies. The other elements to which the CEs can be coupled can include storage elements such as a scratchpad memory, one or more levels of cache storage, control units, multiplier units, address generator units for generating load (LD) and store (ST) addresses, buffers, register files, and so on. The compiler to which each compute element is known can include a C, C++, or Python compiler. The compiler to which each compute element is known can include a compiler written especially for the array of compute elements. The coupling of each CE to its neighboring CEs enables clustering of compute resources; sharing of array elements such as cache elements, multiplier elements, ALU elements, or control elements; communication between or among neighboring CEs; and the like.

Further embodiments can include grouping a subset of compute elements within the array of compute elements. The subset of compute elements can comprise a cluster, a collection, a group, and so on. In embodiments, the subset can include compute elements that are adjacent to at least two other compute elements within the array of compute elements. The adjacent compute elements can share array resources such as control storage, scratchpad storage, communication paths, and the like. The compute elements can further include a topology suited to machine learning functionality, where the machine learning functionality is mapped by the compiler. A topology for machine learning can include supervised learning, unsupervised learning, reinforcement learning, and other machine learning topologies. The compute elements can be coupled to other elements within the array of CEs. In embodiments, the coupling of the compute elements can enable one or more further topologies. The other elements to which the CEs can be coupled can include storage elements such as one or more levels of cache storage, control units, multiplier units, address generator units for generating load (LD) and store (ST) addresses, queues, register files, and so on. The compiler to which each compute element is known can include a C, C++, or Python compiler. The compiler to which each compute element is known can include a compiler written especially for the array of compute elements. The coupling of each CE to its neighboring CEs enables clustering of compute resources; sharing of elements such as cache elements, multiplier elements, ALU elements, or control elements; communication between or among neighboring CEs; and the like.

The flow 100 includes providing control 120 for the compute elements on a cycle-by-cycle basis. The controlling the array can include configuration of elements such as compute elements within the array; loading and storing data; routing data to, from, and among compute elements; and so on. In embodiments, the compiler can provide static scheduling for the array of compute elements. A cycle can include a clock cycle, an architectural cycle, a system cycle, a self-timed cycle, and the like. In the flow 100, the control is enabled by a stream of control words 122 generated and provided by the compiler 124. The control words can include microcode control words, compressed control words, encoded control words, and the like. The “wideness” or width of the control words allows a plurality of compute elements within the array of compute elements to be controlled by a single wide control word. For example, an entire row of compute elements can be controlled by that wide control word. In embodiments, the stream of wide control words can include variable length control words generated by the compiler. The control words can be decompressed, used, etc., to configure the compute elements and other elements within the array; to enable or disable individual compute elements, rows and/or columns of compute elements; to load and store data; to route data to, from, and among compute elements; and so on. In other embodiments, the stream of wide control words generated by the compiler can provide direct, fine-grained control of the array of compute elements. The fine-grained control of the compute elements can include enabling or idling individual compute elements; enabling or idling rows or columns of compute elements; etc.

The compiler can be used to map functionality to the array of compute elements. In embodiments, the compiler can map machine learning functionality to the array of compute elements. The machine learning can be based on a machine learning (ML) network, a deep learning (DL) network, a support vector machine (SVM), etc. In embodiments, the machine learning functionality can include a neural network (NN) implementation. The neural network implementation can include a plurality of layers, where the layers can include one or more of input layers, hidden layers, output layers, and the like. A control word generated by the compiler can be used to configure one or more CEs, to enable data to flow to or from the CE, to configure the CE to perform an operation, and so on. Depending on the type and size of a task that is compiled to control the array of compute elements, one or more of the CEs can be controlled, while other CEs are unneeded by the particular task. A CE that is unneeded can be marked in the control word as unneeded. An unneeded CE requires no data and no control word. In embodiments, the unneeded compute element can be controlled by a single bit. In other embodiments, a single bit can control an entire row of CEs by instructing hardware to generate idle signals for each CE in the row. The single bit can be set for “unneeded”, reset for “needed”, or set for a similar usage of the bit to indicate when a particular CE is unneeded by a task. The control words are generated by the compiler. The control words that are generated by the compiler can include a conditionality such as a branch. The branch can include a conditional branch, an unconditional branch, etc. The control words that are compressed can be decompressed by a decompressor logic block that decompresses words from a compressed control word cache on their way to the array. In embodiments, the provided control can include a spatial allocation of subtasks on one or more compute elements within the array of compute elements. In other embodiments, the set of provided control can enable multiple, simultaneous programming loop instances circulating within the array of compute elements. The multiple programming loop instances can include multiple instances of the same programming loop, multiple programming loops, etc.

The flow 100 includes enabling memory access operation hazard mitigation 130. Processes, tasks, subtasks, and so on can be executed on the array of compute elements. While some of the tasks, for example, can be executed in parallel, others have to be properly sequenced. Execution of the tasks, whether sequentially or in parallel, is dictated in part by any data dependencies between or among tasks. In embodiments, the precedence information enables correct hardware ordering of loads and stores. That is, the loads and stores must occur in the correct order to ensure validity of data that is processed, and by extension the processing results. In embodiments, the precedence information can provide semantically correct operation ordering. To demonstrate this latter point, consider a usage example in which a task A processes input data and produces output data that is required by task B. Thus, task A must be executed prior to executing task B for correct results. Task C, however, executes tasks that process the same input data as task A and produces its own output data. Thus, task C can be executed in parallel with tasks A and B. In embodiments, the loads and stores can include memory access loads to the array of compute elements and memory access stores from the array of compute elements.

The execution of tasks can be based on memory access operations, where the memory access operations include data loads from memory, data stores to memory, and so on. If in the example just recited, task B were to attempt to access data before task A had produced the required data, a hazard would occur. Thus, hazard detection and mitigation can be critical to successful parallel processing. In embodiments, the hazards can include write-after-read, read-after-write, and write-after-write conflicts. The hazard mitigation can be accomplished by memory access operation precedence. In the flow 100, hazard mitigation is enabled by a control word tag 132, wherein the control word tag supports memory access precedence information and is provided by the compiler at compile time. The control word tag can be included in the control word, can be associated with the control word, and so on. The control word can include a number of bits, bytes, and so on. In embodiments, the control word tag can include five bits. The control word tag can include a fixed length tag, a variable length tag, etc. In other embodiments, hazard detection can be based on identifying memory access operations that access the same address. Precedence information associated with each memory access operation can be used to coordinate memory access operations so that valid data can be loaded, and to ensure that valid data is not corrupted by a store operation overwriting the valid data. Techniques for hazard detection and mitigation can include holding memory access data before promotion, delaying promoting data to the access buffer and/or releasing data from the access buffer, and so on.

The flow 100 includes executing 140 a hazardless memory access operation, wherein the hazardless memory access operation is determined by the compiler. The compiler, at compile time, can identify memory access loads and memory access stores that must be executed sequentially, can be executed in parallel, and so on. In embodiments, the hazardless memory access can include safe loads from a data cache. A safe load can include data that is unlikely to change. In embodiments, the safe load can include a constant value. The safe load can further include coefficient values, weights, and the like. In other embodiments, the safe load can include a read probe. A read probe can be used to determine wither two or more operations are targeting the same address. Discussed further below, in embodiments, memory access precedence information provided by the compiler can enable intra-control word precedence. The intra-control word precedence can be used to order two or more operations which can be present in a given control word. In other embodiments, the hazardless memory access can include safe stores to a data cache. The data cache can include a single-level cache, a multilevel cache, and the like. In embodiments, the safe store can include a single compute element operation. The single compute element operation can include a read-modify-write (RMW) operation. In other embodiments, multiple compute elements can cooperatively execute a RMW operation. A compiler-based RMW operation comprises a constructed atomic operation across multiple cycles. Because memory access addresses cannot be known at compile time, to guarantee there will be no other accesses that potentially alias into the RMW memory access addresses, the hazard detection and mitigation techniques described herein can enable virtual single cycle RMW behavior across multiple cycles when other memory accesses may be occurring in parallel. In further embodiments, the safe store can include a store probe. The store probe can be used to determine whether operations include memory access operations to the same memory, or storage, address.

In the flow 100, the hazardless memory access operation is designated 142 by a unique set of precedence information contained in the tag. The unique precedence information can include a memory operation number, a return count number, and so on. The order operation numbers associated with operations within a control word can be compared to determine an order of execution. The return count can be used to specify how many cycles, such as compiler cycles, can elapse before the operation must be completed. In embodiments, the unique precedence information contained in the tag can include a unique tag field. The unique tag field can comprise a fixed length or a variable length tag. In embodiments, the unique tag field can support multiple control word memory accesses. The multiple control word memory accesses can include one or more of loads or stores. In embodiments, the unique tag field can indicate safe/unsafe memory access. The safe/unsafe memory access can include access to a constant or not. In further embodiments, the unique precedence information can include an illegal precedence value. An illegal precedence value can be used to indicate that one or more operations associated with a control word can be terminated, suspended, etc. In embodiments, the unique set of precedence information contained in the tag that was modified during runtime enables inter-control word precedence. The inter-control word precedence can be used to indicate a taken side of a branch instruction.

Memory access operations such as loads can be subject to latency, where the latency can be associated with congestion on a bus, with a transit time associated with a crossbar switch, with latency associated with the storage in which the requested data is located, and so on. The memory access latency can vary by order of magnitude depending on where the data is located. The memory in which the data can be located can include memory local to the array, a scratch pad, a cache memory, a memory system, etc. Further, the memory implementation can include memory such as SRAM, DRAM, non-volatile memory, etc., and can directly influence latency. The flow 100 further includes modifying the tag 144 during runtime. The modifying the tag during runtime can adjust for memory access latencies associated with tasks and subtask operations executing at the time of a memory access operation. The modifying the tag during runtime can alter architectural (compiler) clock duration latency. In embodiments, the modifying can be performed by hardware. The hardware can include a compute element, a modifying element within or coupled to the array, and the like. In embodiments, the hardware modifying can be based on a change of memory access hazards.

Discussed in detail below, a change in memory access hazards can result from a change in operation execution sequence. In embodiments, the change of memory access hazards can result from a branch operation decision. Since execution of all sides of a branch can begin prior to a branch decision being made, various memory access operations that are associated with each side of the branch operation can be initiated. When the branch decision is made, the taken path can proceed, and memory access operations associated with the taken side can likewise proceed. The memory access operations associated with the untaken side or side are terminated, thereby changing memory access hazards. In other embodiments, the change of memory access hazards can result from a long access data load. The long data access can result from a cache miss, requiring access to a memory system to obtain load data. In embodiments, the long access data load can include a memory access from dynamic random-access memory (DRAM). A load access latency to a DRAM can be longer in comparison to load access of an SRAM because of overhead such as a refresh associated with the DRAM. In other embodiments, the long access data load comprises a memory access from non-volatile storage. The non-volatile storage can be implemented using a variety of techniques. In embodiments, the non-volatile storage can include NAND flash storage. Other nonvolatile storage techniques can be based on resistive RAM (ReRAM), spin-transfer torque RAM (STTRAM), etc.

Discussed above and throughout, the operations that are executed can be associated with a task, a subtask, and so on. The operations can include arithmetic, logic, array, matrix, tensor, and other operations. A number of iterations of executing operations can be accomplished based on the contents of the operation counter within a given compute element. The particular operation or operations that are executed in a given cycle can be determined by a set of control word operations. The compute element can be enabled for operation execution, idled for a number of cycles when the compute element is not needed, etc. Recall that the operations that are executed can be repeated. In embodiments, each set of operations associated with one or more control words can enable operational control of a particular compute element for a discrete cycle of operations. An operation can be based on the plurality of control bunches (i.e., sequences of operations) for a given compute element using its autonomous operation buffer(s). The operation that is being executed can include data dependent operations. In embodiments, the plurality of control words includes two or more data dependent branch operations. The branch operation can include two or more branches where a branch is selected based on an operation such as an arithmetic or logical operation. In a usage example, a branch operation can determine the outcome of an expression such as A>B. If A is greater than B, then one branch can be taken. If A is less than or equal to B, then another branch can be taken. In order to speed execution of a branch operation, sides of the branch can be precomputed prior to datum A and datum B being available. When the data is available, the expression can be computed, and the proper branch direction can be chosen. The untaken branch data and operations can be discarded, flushed, etc. In embodiments, the two or more data dependent branch operations can require a balanced number of execution cycles. The balanced number of execution cycles can reduce or eliminate idle cycles, stalling, and the like. In embodiments, the balanced number of execution cycles is determined by the compiler. In embodiments, the accessing, the providing, the loading, and the executing enable background memory accesses. The background memory access enables a control element to access memory independently of other compute elements, a controller, etc. In embodiments, the background memory accesses can reduce load latency. Load latency is reduced since a compute element can access memory before the compute element exhausts the data that the compute element is processing.

Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

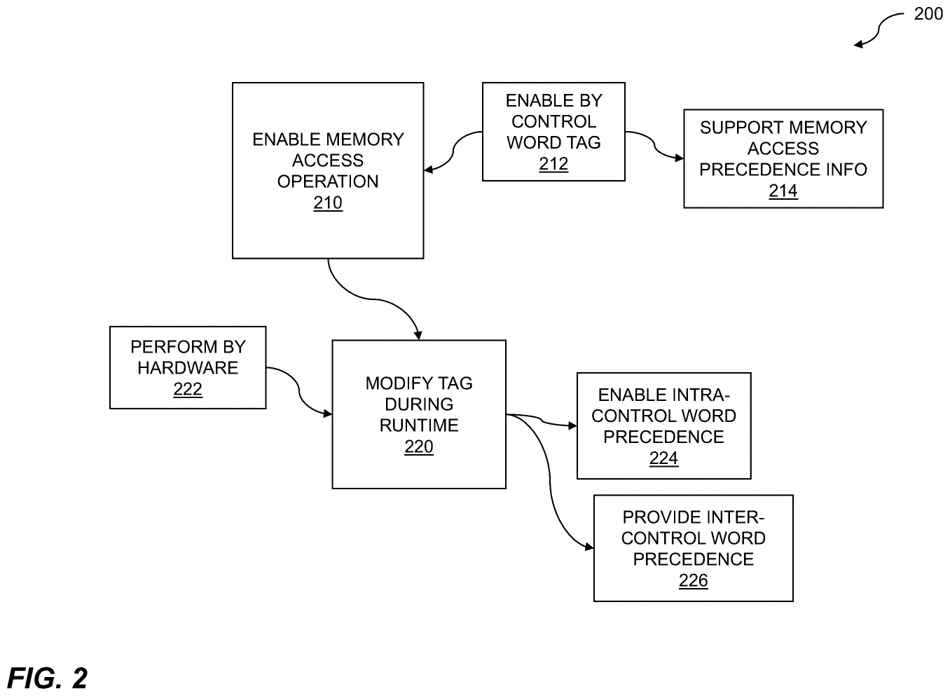

FIG. 2 is a flow diagram for control word tag usage. Discussed previously, memory access operation hazard mitigation is enabled by a control word tag. The control word tag can be used to support memory access precedence information. The control word tag can include a unique set of precedence information contained in the tag. The unique precedence information can designate a hazardless memory access operation. The control word tag further enables parallel processing hazard mitigation avoidance. An array of compute elements is accessed, wherein each compute element within the array of compute elements is known to a compiler and is coupled to its neighboring compute elements within the array of compute elements. Control for the compute elements is provided on a cycle-by-cycle basis, wherein control is enabled by a stream of wide control words generated by the compiler. Memory access operation hazard mitigation is enabled, wherein the hazard mitigation is enabled by a control word tag, wherein the control word tag supports memory access precedence information and is provided by the compiler at compile time. A hazardless memory access operation is executed, wherein the hazardless memory access operation is determined by the compiler, and wherein the hazardless memory access operation is designated by a unique set of precedence information contained in the tag.

Memory access operations such as load operations and store operations can originate from one or more compute elements within an array of compute elements. One or more buffers, such as autonomous operation buffers, can be used to control one or more elements such as compute elements within an array of elements. Collections, clusters, or groupings of compute elements (CEs), such as CEs assembled within an array of CEs, can be configured using control words. The control words can decode (if encoded) and can be used to execute a variety of operations associated with programs, codes, apps, and so on. The operations can be based on tasks, and on subtasks that are associated with the tasks. The array can further interface with other elements such as controllers, storage elements, arithmetic logic units (ALUs), memory management units (MMUs), graphics processor units (GPUs), multicycle elements, multiplier elements, convolvers, neural networks, and the like. The operations can accomplish a variety of processing objectives such as application processing, data manipulation, design, emulation, simulation, and so on. The operations can perform manipulations of a variety of data types including integer, real, floating point, and character data types; vectors and matrices; tensors; etc. Control is provided to the array of compute elements on a cycle-by-cycle basis, where the control is based on control words generated by a compiler. The control words, which can include microcode control words, enable or idle various compute elements; provide data; route results between or among CEs, caches, and storage; and the like. The control can be based on a stream of control words, where the stream of control words comprises wide, variable length, control words generated by the compiler. Operations contained in one or more control words can be loaded into one or more autonomous operation buffers, where the autonomous operation buffers are integrated in one or more compute elements. The control, which is based on the provided control words, enables compute element operation, memory access precedence, etc. The control words provide operational control of a particular compute element. Compute element operation and memory access precedence enable the hardware to properly sequence compute element results.

Sets of control words can be stored in buffers that are accessible to a controller. The controller uses the control words to configure array elements such as compute elements and enables execution of a compiled program on the array. The compiled program can be based on tasks, subtasks, etc. The compute elements can access registers, scratchpads, caches, and so on, that contain compressed and decompressed control words, data, etc. The caches, which can include instruction caches and data caches, can include single-level caches, multi-level caches, and so on. The control based on the control words enables autonomous compute element operation using buffers.

The compute elements can further include one or more topologies, where a topology can be mapped by the compiler. The topology mapped by the compiler can include a graph such as a directed graph (DG) or directed acyclic graph (DAG), a Petri Net (PN), etc. In embodiments, the compiler maps machine learning functionality to the array of compute elements. The machine learning can be based on supervised, unsupervised, and semi-supervised learning; deep learning (DL); and the like. In embodiments, the machine learning functionality can include a neural network implementation. The compute elements can be coupled to other elements within the array of CEs. In embodiments, the coupling of the compute elements can enable one or more topologies. The other elements to which the CEs can be coupled can include storage elements such as one or more levels of cache storage, multiplier units, address generator units for generating load (LD) and store (ST) addresses, queues, and so on. The compiler to which each compute element is known can include a C, C++, or Python compiler. The compiler to which each compute element is known can include a compiler written especially for the array of compute elements. The coupling of each CE to its neighboring CEs enables sharing of elements such as cache elements, multicycle elements (multiplication, logarithm, square root, etc.), ALU elements, or control elements; communication between or among neighboring CEs; and the like.

The flow 200 includes enabling memory access operation 210. The memory access operation can be based on hazard mitigation. The memory access operation can include a read or load operation, a write or store operation, and so on. The memory access operation can access a variety of types of storage such as one or more types of storage within the array of compute elements, a scratchpad memory, a cache memory, a memory system, and so on. The cache memory can include a single-layer cache, a multi-layer cache, etc. The memory system can comprise static random-access memory (SRAM), dynamic random-access memory (DRAM), non-volatile memory (NVM), etc. In the flow 200, the hazard mitigation is enabled by a control word tag 212. The control word precedence tag can comprise a number of bits, bytes, etc. The control word precedence tag can include a fixed number of bits or bytes, a variable number of bits or bytes, and the like. In the flow 200, the control word precedence tag supports memory access precedence information 214 and is provided by the compiler at compile time. The compiler can include a high-level compiler such as C, C++, or Python; a hardware description language (HDL) such as Verilog or VHDL; a language tailored to the compute elements within the array; etc.

The flow 200 further includes modifying the tag during runtime 220. At compile time, the compiler can determine orders of operations, can enable early memory access operations, and so on. However, the compiler cannot necessarily know a priori the memory access latencies and propagation delays due to congestion, among other things, of tasks that can be executing on the array of compute elements at a given time. The tasks and subtasks that are running can issue memory access operations, thereby affecting memory access operation latency. Further, execution of control words can be based on decisions such as branch decisions that can be made during runtime. As a result, the precedence tag can be modified to accommodate the memory access order required for semantic correctness, which can be independent of access latency. In the flow 200, the modifying can be performed by hardware 222. The hardware that can modify the tag can include a compute element within the array; a tag modifying element within the array, accessible to the array, or coupled to the array; and so on. In embodiments, the hardware modifying can be based on a change of memory access hazards. The memory access hazards can result from different control words being presented to the compute elements. In embodiments, the change of memory access hazards can result from a branch operation decision. Recall that each side of a branch operation can begin execution prior to a branch decision being determined. Then, when the branch decision is determined, the taken branch can proceed, and any untaken branches can be terminated. The termination of untaken branches changes memory access hazards by eliminating memory access operations associated with any untaken branches.

In other embodiments, the change of memory access hazards can result from a long access data load. In a usage example, an address associated with a data load can first be compared to the contents of a local memory such as cache memory. If the data is not present in the cache, then a cache miss occurs and the data load operation must seek the data elsewhere, such as in DRAM-based main memory, which can be located off chip. The long access data load can result from the type of memory used to store the requested data. In embodiments, the long access data load can include a memory access from dynamic random-access memory (DRAM). Since DRAM access can be slower and can require more access overhead (e.g., data refresh) than a static RAM (SRAM), the data load operation can take longer. Thus, one or more tags can be modified to consider the long access data load. In other embodiments, the long access data load can include a memory access from non-volatile storage.

In the flow 200, memory access precedence information provided by the compiler enables intra-control word precedence 224. A control word, generated by a compiler, can include one or more operations. The operations can include arithmetic and logical operations, memory access operations, and so on. The order in which the operations are included in the control word can imply an order of operation. The precedence information in the tag can provide a memory operation order, a return count of a number of cycles that can occur before completion of the memory access operation, and the like. In embodiments, the control word tag can include a unique set of precedence information, where the unique set of precedence information enables hazardless memory accesses. In the flow 200, the unique set of precedence information contained in the tag that was modified during runtime can enable inter-control word precedence 226. The inter-control word precedence can be based on a decision such as a branch decision. The branch decision determines which side of a branch is taken and determines which sequence of control words will continue execution. In embodiments, the unique precedence information contained in the tag can include a unique tag field. The unique tag field can include a constant or variable width. In other embodiments, the unique tag field can support multiple control word memory accesses. The multiple control word memory accesses can access different buffers such as access buffers associated with a cache memory, a multi-level cache, a memory system, etc. In embodiments, the unique tag field indicates safe/unsafe memory access. A safe memory access can include an access to load constants, coefficients, weights, etc. In other embodiments, the safe load can include a read probe. A read probe can compare a read or load address to addresses accessible within a cache, a multi-level cache, and the like. In other embodiments, the unique precedence information can include an illegal precedence value. The illegal precedence value can be used to prevent a memory access operation.

A description of a usage example follows. A decoded control word can generate memory access operations. Assuming there can be 64 memory accesses per decompressed control word (DCW) (32 per data cache bank), then a minimum precedence information required can be 4 bits per read and per write per column of the data cache, or a total of 8 bytes per data cache bank. It is important to provide a signal to hardware to advise when an access is known and safe and can be ignored. A 5-bit field can be used for each Load or Store access, where the value 00000 can indicate that the Load or Store is “safe”. An example of a “safe” address is a very early “probe” read of a column of a level 1 (L1) data cache D$ to “warm” or preload the data cache with data expected to be fetched later. Issuing actual load operations as early as possible can minimize performance impact of memory latency since there can be a significant temporal spread between the issue of a load operation and the decompressed control word that will consume the data (move the data into the array). Hence, precedence tags must continue to be valid across this temporal spread to maintain semantic correctness. Hardware maintains a separate counter, incremented for each successive decompressed control word and appended (upper bits) to the decompressed control word precedence information to provide a unique tag for each access that is valid across multiple decompressed control words.

Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

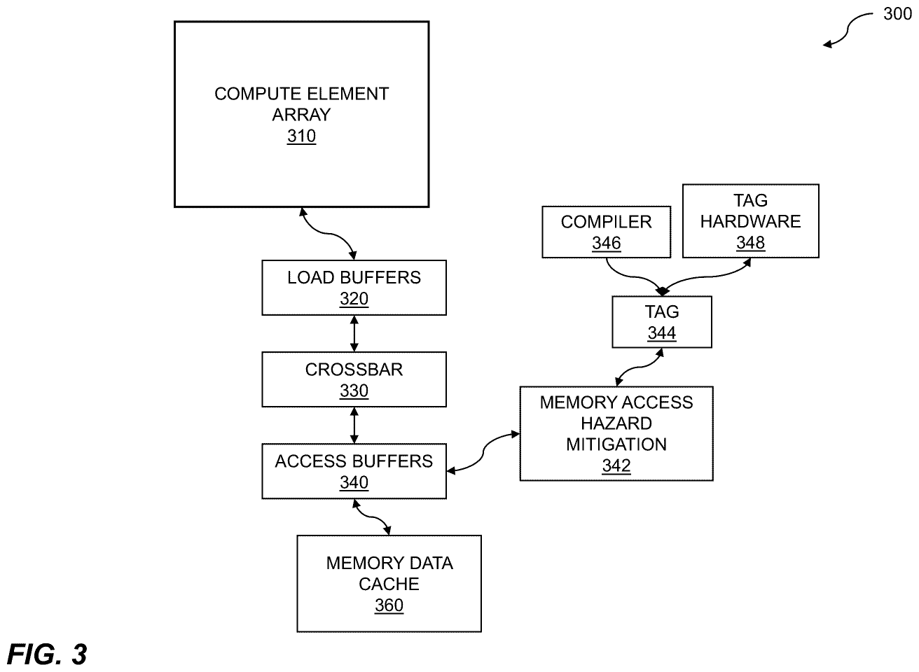

FIG. 3 is a system block diagram showing hazard detection and mitigation. The hazard detection and mitigation can be accomplished using parallel processing hazard mitigation avoidance. An array of elements can be configured to process data. As discussed previously and throughout, the elements can include compute elements, processing elements, buffers, one or more levels of cache storage, system management, arithmetic logic units, multicycle elements, memory management units, and so on. Data can be loaded from a memory such as a cache memory into the compute elements for processing, and results of the processing can be stored back to memory. Since the array of compute elements can be configured for parallel processing applications, the order in which the data loads and the data stores are executed is critical. The data to be loaded must be valid, and the data that is stored must not overwrite valid data yet to be loaded for processing. Loading invalid data or storing data over valid data are considered memory access hazards. Various memory access operation hazards can be mitigated by using a control word tag. The control word tag can be generated by a compiler at compile time. The control word tag can include a variety of information such as a memory operation number, a return count, and so on. The tag can be modified during runtime. The modifying can be based on a change of memory access hazards based on results of an operation such as a branch decision. The modifying can further be based on a long access data load. An array of compute elements is accessed, wherein each compute element within the array of compute elements is known to a compiler and is coupled to its neighboring compute elements within the array of compute elements. Control for the compute elements is provided on a cycle-by-cycle basis, wherein control is enabled by a stream of wide control words generated by the compiler. Memory access operation hazard mitigation is enabled, wherein the hazard mitigation is enabled by a control word tag, wherein the control word tag supports memory access precedence information and is provided by the compiler at compile time. A hazardless memory access operation is executed, wherein the hazardless memory access operation is determined by the compiler, and wherein the hazardless memory access operation is designated by a unique set of precedence information contained in the tag.

Processes, tasks, subtasks, and so on can be executed on a parallel processing architecture. Some of the tasks, for example, can be executed in parallel, while others have to be properly sequenced. The sequential execution and the parallel execution of the tasks are dictated in part by the existence of or absence of data dependencies between tasks. In a usage example, a task A processes input data and produces output data that is required by task B. Thus, task A must be executed prior to executing task B. Task C, however, executes tasks that process the same input data as task A and produces output data. Thus, task C can be executed in parallel with task A. The execution of tasks can be based on memory access operations, where the memory access operations include data loads from memory, data stores to memory, and so on. If, in the example just recited, task B were to attempt to access and process data prior to task A producing the data required by task B, a hazard would occur. Thus, hazard detection and mitigation can be critical to successful parallel processing. In embodiments, the hazards can include write-after-read, read-after-write, and write-after-write conflicts. The hazard detection can be based on identifying memory access operations that access the same address. Precedence information associated with each memory access operation can be used to coordinate memory access operations so that valid data can be loaded, and to ensure that valid data is not corrupted by a store operation overwriting the valid data. Techniques for hazard detection and mitigation can include holding memory access data before promotion, delaying the promoting of data to the access buffer and/or releasing data from the access buffer, and so on. Further techniques can enable hazard mitigation by using a control word tag. The control word tag can include key information such as memory access precedence information. The precedence information can enable hazardless memory access operations.

Data can be moved between a memory such as a memory data cache, and storage elements associated with the array of compute elements. The storage elements associated with the array of compute elements can include scratchpad memory, register files, and so on. Memory access operations can include loads from memory, stores to memory, memory-to-memory transfers, etc. The storage elements can include local storage coupled to one or more compute elements within an array of compute elements, storage associated with the array, cache storage, a memory system, and so on. A load memory access operation can load control words, compressed control words, bunches of bits associated with control words, data, and the like. Memory access operations enable parallel processing using hazard mitigation avoidance. An array of compute elements is accessed, wherein each compute element within the array of compute elements is known to a compiler and is coupled to its neighboring compute elements within the array of compute elements. Control for the compute elements is provided on a cycle-by-cycle basis, wherein control is enabled by a stream of wide control words generated by the compiler. Memory access operation hazard mitigation is enabled, wherein the hazard mitigation is enabled by a control word tag, wherein the control word tag supports memory access precedence information and is provided by the compiler at compile time. A hazardless memory access operation is executed, wherein the hazardless memory access operation is determined by the compiler, and wherein the hazardless memory access operation is designated by a unique set of precedence information contained in the tag.

Hazard detection and mitigation is illustrated in block diagram 300. The hazard mitigation can be based on hazard mitigation avoidance. One or more hazards, which can be encountered during memory access operations, can result when two or more memory access operations attempt to access the same memory address. While multiple loads (reads) from an address may not create a hazard, combinations of loads and stores to the same address are problematic. Hazard detection and mitigation techniques enable memory access operations to be performed while avoiding hazards. The memory access operations include loading data from memory and storing data to memory. The data is loaded from memory to supply data to tasks, subtasks, and so on to be executed on an array. Data produced by the tasks and subtasks can be stored back to the memory. The array can include an array of compute elements 310. The array can include a two-dimensional array, stacked two-dimensional arrays that can form a three-dimensional array, and so on. The data can be loaded or stored based on a number of bytes, words, blocks, etc.

Data movement, whether loading, storing, transferring, etc., can be accomplished using a variety of techniques. In embodiments, memory access operations can be performed outside of the array of compute elements, thereby freeing the compute elements to execute tasks, subtasks, etc. Memory access operations, such as autonomous memory operations, can preload data needed by one or more compute elements. In additional embodiments, a semi-autonomous memory copy technique can be used for transferring data. The semi-autonomous memory copy technique can be accomplished by the array of compute elements which generates source and target addresses required for the one or more data moves. The array can further generate a data size such as 8, 16, 32, or 64-bit data sizes, and a striding value. The striding value can be used to avoid overloading a column of storage components such as a cache memory. The source and target addresses, data size, and striding can be under direct control of a compiler.

The block diagram 300 can include load buffers 320. The load buffers can include two or more buffers associated with the compute element array. The buffers can be shared by the compute elements within the array, a subset of compute elements can be assigned to each buffer, etc. The load buffers can hold data targeted to one or more compute elements within the array as the data is read from a memory such as data cache memory. The load buffers can be used to accumulate an amount of data before transferring the data to one or more compute elements, to retime (e.g., hold or delay) delivery of data loaded from storage prior to data transfer to compute elements, and the like. The block diagram 300 can include a crossbar switch 330. The crossbar switch can provide selectable communication paths between buffers associated with a memory (discussed shortly below). The crossbar switch enables transit of memory access data between buffers associated with the memory and the load buffers associated with the compute elements. The crossbar switch can enable multiple data access operations within a given cycle.

The block diagram 300 can include access buffers 340. Two or more access buffers can be coupled to a memory such as data cache memory (discussed below). The access buffers can hold data such as store data produced by operations associated with tasks, subtasks, etc. In embodiments, the access buffer can be based on a content addressable memory. The operations are executed using compute elements within the array. In embodiments, the holding can be accomplished using access buffers coupled to a memory cache. The holding can be based on monitoring memory access operations that have been tagged. The tagging can be contained in the control words, and the tagging can be provided by the compiler at compile time. The load data can be held in the access buffers prior to the data transiting the crossbar switch to the load buffers or being directed to compute elements within the array. Since there is a transit latency associated with the crossbar switch, load data can transit the crossbar switch in a number of cycles not able to be determined by the compiler. The block diagram 300 can include a hazard identification component 342. Recall that a hazard can exist when valid data is not available for a memory access load operation requesting the data. Further, a hazard can exist when valid data would be overwritten by a memory access store operation. In embodiments, the hazards can include write-after-read, read-after-write, and write-after-write conflicts. The access buffers can be used as part of a hazard identification technique. Updated memory access store data may be available in the access buffer prior to the data being stored to memory. A determination of whether requested data is still within the access buffer rather than already in the memory can be made by comparing load and store addresses. Further embodiments include identifying hazardous loads and stores by comparing load and store addresses to contents of an access buffer. Recall that hazards can occur when conflicting or mistimed memory access operations are executed. In embodiments, the comparing can identify potential accesses to the same address. The comparing can further include using the precedence information that was used to tag memory access operations. Other embodiments can enable load/store forwarding. Load/store forwarding can access contents of one or more access buffers. The accessed data can be provided or received for load or store operations respectively to accomplish hazard mitigation. In embodiments, the hazard mitigation can include load-to-store forwarding, store-to-load forwarding, and store-to-store forwarding. The forwarding is based on accessing data within one or more access buffers rather than from the memory.

The system block diagram includes a control word tag 344. The control word tag includes information associated with memory access operations. The memory access operations can include one or more of a memory operation number, a return count, and so on. In embodiments, the control word tag can support memory access precedence information. The memory access precedence information can include an order of operations, a priority, and the like. The control word tag can enable early memory access load operations. The early loads enable accessing of data associated with operations which can occur later in a sequence of operations. The early accessing not only can ensure that data is available for an operation when the operation is ready for execution, but can also be used to control or reduce data transfer contention. The data transfer contention can be associated with a bus, a crossbar switch, memory accesses such as cache memory accesses and memory system accesses, etc. The system block diagram includes a compiler 346. The compiler can be used to provide memory access precedence information. The compiler can include a high-level compiler such as a C, C++, or Python compiler; a hardware description language compiler such as a Verilog or VHDL compiler; a specialized compiler developed for use with the compute elements within the array; and so on. The memory access precedence information provided by the compiler can enable hazardless memory access operation execution. In embodiments, the hazardless memory access operation can be designated by a unique set of precedence information contained in the tag.

Noted previously, the control word tag supports memory access precedence information, and the control word tag is provided by the compiler at compile time. However, the compiler cannot necessarily know a priori the exact mix of tasks, subtasks, and so on that can be executing on compute elements within the array at a given time. The tasks and subtasks that are executing at a given time generate memory access load and store operations, where each memory access consumes some system resources while executing the memory access. The tag can be changed, updated, etc. during runtime. The system block diagram includes tag hardware 348. The tag hardware can be used to modify the tag during runtime. The need to modify a tag during runtime can result from changes in instruction streams, differing memory access times, etc. In embodiments, the hardware modifying can be based on a change of memory access hazards. The change in memory access hazards can result from a change in operation flow. In embodiments, the change of memory access hazards can result from a branch operation decision. Recall that execution of two or more sides of a branch can begin prior to a branch determination. Each side of the branch can include load or store requests, operations, branches, etc. When the branch decision is determined, execution of the taken side of the branch can continue, while the untaken side or sides of the branch can be terminated. The termination of the operations associated with the one or more untaken sides of the branch changes memory access hazards. Further, the change of memory access hazards can be dependent on the type of memory that is accessed by a load or store request. Access to some memories can cause a long access data load. In embodiments, the long access data load can include a memory access from dynamic random-access memory (DRAM). In other embodiments, the long access data load can include a memory access from non-volatile storage.

The system block diagram includes a memory data cache 360. The cache can include one or more levels of cache. In embodiments, the cache can include levels such as a level 1 (L1) cache, a level 2 (L2) cache, a level 3 (L3) cache, and so on. The L1 cache can include a small, fast memory that is accessible to the compute elements within the compute element array. The L2 cache can be larger than the L1 cache, and the L3 cache can be larger than the L2 cache and the L1 cache. When a compute element within the array initiates a load operation, the data associated with the load operation is first sought in the L1 cache, then the L2 cache if absent from the L1 cache, then the L3 cache if the load operation causes a “miss” (e.g., the requested data is not located in a cache level). The L1 cache, the L2 cache, and the L3 cache can store data, control words, compressed control words, and so on. In embodiments, the L3 cache can comprise a unified cache for data and compressed control words (CCWs).

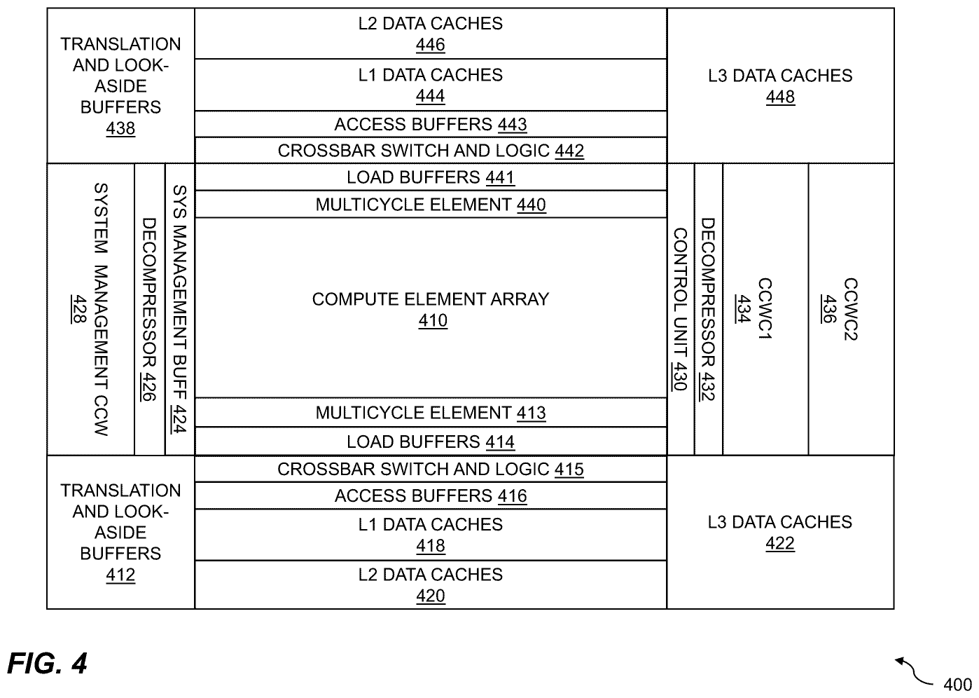

FIG. 4 illustrates a system block diagram for a highly parallel architecture with a shallow pipeline. The highly parallel architecture can comprise components including compute elements, processing elements, buffers, one or more levels of cache storage, system management, arithmetic logic units, multicycle elements for computing multiplication, division, and square root operations, and so on. The various components can be used to accomplish parallel processing of tasks, subtasks, and the like. The parallel processing is associated with program execution, job processing, etc. The parallel processing is enabled based on hazard mitigation avoidance. An array of compute elements is accessed, wherein each compute element within the array of compute elements is known to a compiler and is coupled to its neighboring compute elements within the array of compute elements. Control for the compute elements is provided on a cycle-by-cycle basis, wherein control is enabled by a stream of wide control words generated by the compiler. Memory access operation hazard mitigation is enabled, wherein the hazard mitigation is enabled by a control word tag, wherein the control word tag supports memory access precedence information and is provided by the compiler at compile time. A hazardless memory access operation is executed, wherein the hazardless memory access operation is determined by the compiler, and wherein the hazardless memory access operation is designated by a unique set of precedence information contained in the tag.

A system block diagram 400 for a highly parallel architecture with a shallow pipeline is shown. The system block diagram can include a compute element array 410. The compute element array 410 can be based on compute elements, where the compute elements can include processors, central processing units (CPUs), graphics processing units (GPUs), coprocessors, and so on. The compute elements can be based on processing cores configured within chips such as application specific integrated circuits (ASICs), processing cores programmed into programmable chips such as field programmable gate arrays (FPGAs), and so on. The compute elements can comprise a homogeneous array of compute elements. The system block diagram 400 can include translation and look-aside buffers such as translation and look-aside buffers 412 and 438. The translation and look-aside buffers can comprise memory caches, where the memory caches can be used to reduce storage access times.

The system block diagram 400 can include logic for load and store access order and selection. The logic for load and store access order and selection can include crossbar switch and logic 415 along with crossbar switch and logic 442. Crossbar switch and logic 415 can accomplish load and store access order and selection for the lower data cache blocks (418 and 420), and crossbar switch and logic 442 can accomplish load and store access order and selection for the upper data cache blocks (444 and 446). Crossbar switch and logic 415 enables high-speed data communication between the lower-half compute elements of compute element array 410 and data caches 418 and 420 using access buffers 416. Crossbar switch and logic 442 enables high-speed data communication between the upper-half compute elements of compute element array 410 and data caches 444 and 446 using access buffers 443. The access buffers 416 and 443 allow logic 415 and logic 442, respectively, to hold, load, or store data until any memory hazards are resolved. In addition, splitting the data cache between physically adjacent regions of the compute element array can enable the doubling of load access bandwidth, the reducing of interconnect complexity, and so on. While loads can be split, stores can be driven to both lower data caches 418 and 420 and upper data caches 444 and 446.

The system block diagram 400 can include lower load buffers 414 and upper load buffers 441. The load buffers can provide temporary storage for memory load data so that it is ready for low latency access by the compute element array 410. The system block diagram can include dual level 1 (L1) data caches, such as L1 data caches 418 and 444. The L1 data caches can be used to hold blocks of load and/or store data, such as data to be processed together, data to be processed sequentially, and so on. The L1 cache can include a small, fast memory that is quickly accessible by the compute elements and other components. The system block diagram can include level 2 (L2) data caches. The L2 caches can include L2 caches 420 and 446. The L2 caches can include larger, slower storage in comparison to the L1 caches. The L2 caches can store “next up” data, results such as intermediate results, and so on. The L1 and L2 caches can further be coupled to level 3 (L3) caches. The L3 caches can include L3 caches 422 and 448. The L3 caches can be larger than the L2 and L1 caches and can include slower storage. Accessing data from L3 caches is still faster than accessing main storage. In embodiments, the L1, L2, and L3 caches can include 4-way set associative caches.

The system block diagram 400 can include lower multicycle element 413 and upper multicycle element 440. The multicycle elements (MEMs) can provide efficient functionality for operations that span multiple cycles, such as multiplication operations. The MEMs can provide further functionality for operations that can be of indeterminant cycle length, such as some division operations, square root operations, and the like. The MEMs can operate on data coming out of the compute element array and/or data moving into the compute element array. Multicycle element 413 can be coupled to the compute element array 410 and load buffers 414, and multicycle element 440 can be coupled to compute element array 410 and load buffers 441.

The system block diagram 400 can include a system management buffer 424. The system management buffer can be used to store system management codes or control words that can be used to control the array 410 of compute elements. The system management buffer can be employed for holding opcodes, codes, routines, functions, etc. which can be used for exception or error handling, management of the parallel architecture for processing tasks, and so on. The system management buffer can be coupled to a decompressor 426. The decompressor can be used to decompress system management compressed control words (CCWs) from system management compressed control word buffer 428 and can store the decompressed system management control words in the system management buffer 424. The compressed system management control words can require less storage than the uncompressed control words. The system management CCW component 428 can also include a spill buffer. The spill buffer can comprise a large static random-access memory (SRAM), which can be used to provide rapid support of multiple nested levels of exceptions.

The compute elements within the array of compute elements can be controlled by a control unit such as control unit 430. While the compiler, through the control word, controls the individual elements, the control unit can pause the array to ensure that new control words are not driven into the array. The control unit can receive a decompressed control word from a decompressor 432 and can drive out the decompressed control word into the appropriate compute elements of compute element array 410. The decompressor can decompress a control word (discussed below) to enable or idle rows or columns of compute elements, to enable or idle individual compute elements, to transmit control words to individual compute elements, etc. The decompressor can be coupled to a compressed control word store such as compressed control word cache 1 (CCWC1) 434. CCWC1 can include a cache such as an L1 cache that includes one or more compressed control words. CCWC1 can be coupled to a further compressed control word store such as compressed control word cache 2 (CCWC2) 436. CCWC2 can be used as an L2 cache for compressed control words. CCWC2 can be larger and slower than CCWC1. In embodiments, CCWC1 and CCWC2 can include 4-way set associativity. In embodiments, the CCWC1 cache can contain decompressed control words, in which case it could be designated as DCWC1. In that case, decompressor 432 can be coupled between CCWC1 434 (now DCWC1) and CCWC2 436.

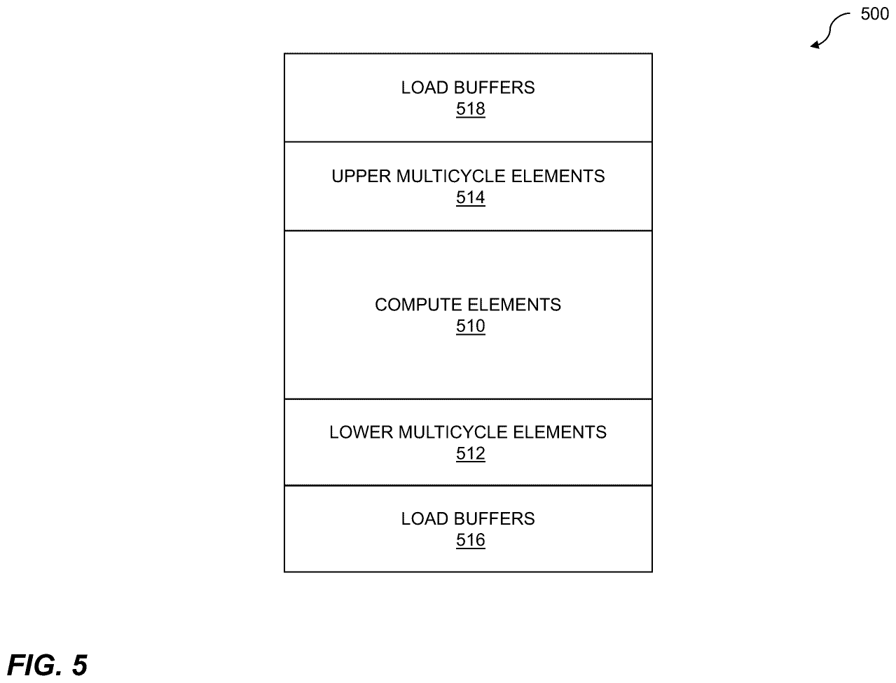

FIG. 5 shows compute element array detail 500. A compute element array can be coupled to components which enable compute elements within the array to process one or more tasks, subtasks, and so on. The tasks, subtasks, etc. can be processed in parallel. The components can access and provide data, perform specific high-speed operations, and the like. The compute element array and its associated components enable parallel processing hazard mitigation avoidance. The compute element array 510 can perform a variety of processing tasks, where the processing tasks can include operations such as arithmetic, vector, matrix, or tensor operations; audio and video processing operations; neural network operations; etc. The compute elements can be coupled to multicycle elements such as lower multicycle elements 512 and upper multicycle elements 514. The multicycle elements can provide functionality to perform, for example, high-speed multiplications associated with general processing tasks, multiplications associated with neural networks such as deep learning networks, multiplications associated with vector operations, and the like. The multiplication operations can span multiple cycles. The MEMs can provide further functionality for operations that can be of indeterminant cycle length, such as some division operations, square root operations, and the like.

The compute elements can be coupled to load buffers such as load buffers 516 and load buffers 518. The load buffers can be coupled to the L1 data caches as discussed previously. In embodiments, a crossbar switch (not shown) can be coupled between the load buffers and the data caches. The load buffers can be used to load storage access requests from the compute elements. When an element is not explicitly controlled, it can be placed in the idle (or low power) state. No operation is performed, but ring buses can continue to operate in a “pass thru” mode to allow the rest of the array to operate properly. When a compute element is used just to route data unchanged through its ALU, it is still considered active.

While the array of compute elements is paused, background loading of the array from the memories (data memory and control word memory) can be performed. The memory systems can be free running and can continue to operate while the array is paused. Because multicycle latency can occur due to control signal transport that results in additional “dead time”, allowing the memory system to “reach into” the array and to deliver load data to appropriate scratchpad memories can be beneficial while the array is paused. This mechanism can operate such that the array state is known, as far as the compiler is concerned. When array operation resumes after a pause, new load data will have arrived at a scratchpad, as required for the compiler to maintain the statically scheduled model.

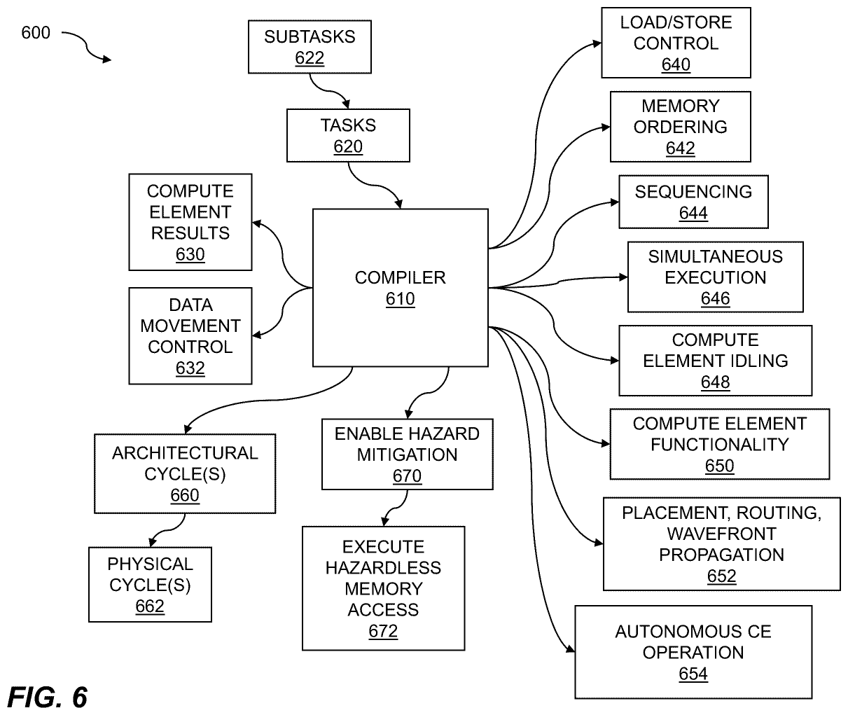

FIG. 6 illustrates a system block diagram for compiler interactions. Discussed throughout, compute elements within a 2D array are known to a compiler which can compile tasks and subtasks for execution on the array. The compiled tasks and subtasks are executed to accomplish parallel processing. A variety of interactions, such as configuration of compute elements, placement of tasks, routing of data, and so on, can be associated with the compiler. The compiler interactions enable parallel processing hazard mitigation avoidance. An array of compute elements is accessed, wherein each compute element within the array of compute elements is known to a compiler and is coupled to its neighboring compute elements within the array of compute elements. Control for the compute elements is provided on a cycle-by-cycle basis, wherein control is enabled by a stream of wide control words generated by the compiler. Memory access operation hazard mitigation is enabled, wherein the hazard mitigation is enabled by a control word tag, wherein the control word tag supports memory access precedence information and is provided by the compiler at compile time. A hazardless memory access operation is executed, wherein the hazardless memory access operation is determined by the compiler, and wherein the hazardless memory access operation is designated by a unique set of precedence information contained in the tag.

The system block diagram 600 includes a compiler 610. The compiler can include a high-level compiler such as a C, C++, Python, or similar compiler. The compiler can include a compiler implemented for a hardware description language such as a VHDL™ or Verilog™ compiler. The compiler can include a compiler for a portable, language-independent, intermediate representation such as low-level virtual machine (LLVM) intermediate representation (IR). The compiler can generate a set of directions that can be provided to the compute elements and other elements within the array. The compiler can be used to compile tasks 620. The tasks can include a plurality of tasks associated with a processing task. The tasks can further include a plurality of subtasks 622. The tasks can be based on an application such as a video processing or audio processing application. In embodiments, the tasks can be associated with machine learning functionality. The compiler can generate directions for handling compute element results 630. The compute element results can include results derived from arithmetic, vector, array, and matrix operations; Boolean operations; and so on. In embodiments, the compute element results are generated in parallel in the array of compute elements. Parallel results can be generated by compute elements when the compute elements can share input data, use independent data, and the like. The compiler can generate a set of directions that controls data movement 632 for the array of compute elements. The control of data movement can include movement of data to, from, and among compute elements within the array of compute elements. The control of data movement can include loading and storing data, such as temporary data storage, during data movement. In other embodiments, the data movement can include intra-array data movement.

As with a general-purpose compiler used for generating tasks and subtasks for execution on one or more processors, the compiler can provide directions for task and subtasks handling, input data handling, intermediate and final result data handling, and so on. The compiler can further generate directions for configuring the compute elements, storage elements, control units, ALUs, and so on, associated with the array. As previously discussed, the compiler generates directions for data handling to support the task handling. In the system block diagram, the data movement can include control of data loads and stores 640 with a memory array. The loads and stores can include handling various data types such as integer, real or float, double-precision, character, and other data types. The loads and stores can load and store data into local storage such as registers, register files, caches, and the like. The caches can include one or more levels of cache such as a level 1 (L1) cache, level 2 (L2) cache, level 3 (L3) cache, and so on. The loads and stores can also be associated with storage such as shared memory, distributed memory, etc. In addition to the loads and stores, the compiler can handle other memory and storage management operations including memory precedence. In the system block diagram, the memory access precedence can enable ordering of memory data 642. Memory data can be ordered based on task data requirements, subtask data requirements, task priority or precedence, and so on. The memory data ordering can enable parallel execution of tasks and subtasks.

In the system block diagram 600, the ordering of memory data can enable compute element result sequencing 644. In order for task processing to be accomplished successfully, tasks and subtasks must be executed in an order that can accommodate task priority, task precedence, a schedule of operations, and so on. The memory data can be ordered such that the data required by the tasks and subtasks can be available for processing when the tasks and subtasks are scheduled to be executed. The results of the processing of the data by the tasks and subtasks can therefore be ordered to optimize task execution, to reduce or eliminate memory contention conflicts, etc. The system block diagram includes enabling simultaneous execution 646 of two or more potential compiled task outcomes based on the set of directions. The code that is compiled by the compiler can include branch points, where the branch points can include computations or flow control. Flow control transfers program execution to a different sequence of control words. Since the result of a branch decision, for example, is not known a priori, the initial operations associated with both paths are encoded in the currently executing control word stream. When the correct result of the branch is determined, the sequence of control words associated with the correct branch result continues execution, while the operations for the branch path not taken are halted and side effects may be flushed. In embodiments, the two or more potential branch paths can be executed on spatially separate compute elements within the array of compute elements.

The system block diagram includes compute element idling 648. In embodiments, the set of directions from the compiler can idle an unneeded compute element within a row of compute elements located in the array of compute elements. Not all of the compute elements may be needed for processing, depending on the tasks, subtasks, and so on that are being processed. The compute elements may not be needed simply because there are fewer tasks to execute than there are compute elements available within the array. In embodiments, the idling can be controlled by a single bit in the control word generated by the compiler. In the system block diagram, compute elements within the array can be configured for various compute element functionalities 650. The compute element functionality can enable various types of compute architectures, processing configurations, and the like. In embodiments, the set of directions can enable machine learning functionality. The machine learning functionality can be trained to process various types of data such as image data, audio data, medical data, etc. In embodiments, the machine learning functionality can include neural network implementation. The neural network can include a convolutional neural network, a recurrent neural network, a deep learning network, and the like. The system block diagram can include compute element placement, results routing, and computation wave-front propagation 652 within the array of compute elements. The compiler can generate directions or instructions that can place tasks and subtasks on compute elements within the array. The placement can include placing tasks and subtasks based on data dependencies between or among the tasks or subtasks, placing tasks that avoid memory conflicts or communications conflicts, etc. The directions can also enable computation wave-front propagation. Computation wave-front propagation can implement and control how execution of tasks and subtasks proceeds through the array of compute elements. In the system block diagram 600, the compiler 610 can enable autonomous compute element (CE) operation 654. As discussed throughout, the autonomous operation is set up by one or more control words generated by the compiler that enable a CE to complete an operation autonomously, that is, not under direct compiler control.

In the system block diagram, the compiler can control architectural cycles 660. An architectural cycle can include an abstract cycle that is associated with the elements within the array of elements. The elements of the array can include compute elements, storage elements, control elements, ALUs, and so on. An architectural cycle can include an “abstract” cycle, where an abstract cycle can refer to a variety of architecture level operations such as a load cycle, an execute cycle, a write cycle, and so on. The architectural cycles can refer to macro-operations of the architecture rather than to low level operations. One or more architectural cycles are controlled by the compiler. Execution of an architectural cycle can be dependent on two or more conditions. Architectural cycles are under direct control of the compiler, as opposed to wall clock cycles which can encompass the indeterminacies of memory operation. In embodiments, an architectural cycle can occur when a control word is available to be driven into the array of compute elements and when all data dependencies are met. That is, the array of compute elements does not have to wait for either dependent data to load or for a full memory queue to clear or drain. In the system block diagram, the architectural cycle can include one or more physical cycles 662. A physical cycle can refer to one or more cycles at the element level that are required to implement a load, an execute, a write, and so on. In embodiments, the set of directions can control the array of compute elements on a physical cycle-by-cycle basis. The physical cycles can be based on a clock such as a local, module, or system clock, or some other timing or synchronizing technique. In embodiments, the physical cycle-by-cycle basis can include an architectural cycle. The physical cycles can be based on an enable signal for each element of the array of elements, while the architectural cycle can be based on a global, architectural signal. In embodiments, the compiler can provide, via the control word, valid bits for each column of the array of compute elements, on the cycle-by-cycle basis. A valid bit can indicate that data is valid and ready for processing, that an address such as a jump address is valid, and the like. In embodiments, the valid bits can indicate that a valid memory load access is emerging from the array. The valid memory load access from the array can be used to access data within a memory or storage element. Similarly, a returning load can be tagged with a valid bit as part of a background load protocol to enable that data to be written into a compute element's memory outside of direct compiler control. In other embodiments, the compiler can provide, via the control word, operand size information for each column of the array of compute elements. Various operand sizes can be used. In embodiments, the operand size can include bytes, half-words, words, and double-words.

Discussed above and throughout, memory access operation hazards can be mitigated. The hazard mitigation can be enabled 670 by a control word tag. The control word tag can include a fixed length tag, a variable length tag, and so on. The control word tag can be used to order operations, load or store data, enable early issuing of load and store operations, preload data, and the like. In embodiments, the control word tag can support memory access precedence information. The memory access precedence information can be used to provide an order in which memory access load and store operations are to be executed. In embodiments, the precedence information can provide semantically correct operation ordering. The correct operation ordering can be based on task or subtask precedence or priority, on an order of operations such as arithmetic operations (e.g., multiplication, division, addition, and subtraction or MDAS), etc. In embodiments, the control word tag is provided by the compiler at compile time. The system block diagram includes hazardless memory access execution 672. The hazardless memory access operation can include accessing a cache such as a data cache, a memory system, and so on. In embodiments, the hazardless memory access operation can be determined by the compiler. The compiler determines the hazardless memory access operation at compile time. In embodiments, the hazardless memory access operation can be designated by a unique set of precedence information contained in the tag. The precedence information can include a memory operation number, where the memory operation number can include a semantic order, a tag, and so on. The precedence information can further include a return count. The return count can include a number of compiler cycles that can elapse prior to load data uptake by the array.

Since the compiler cannot know a priori all possible causes of bus, crossbar switch, cache memory access, memory system access, etc. latencies at compile time, the contents of the tag can be modified to reflect the state of the array while executing tasks, subtasks, and so on. Embodiments further include modifying the tag during runtime. The modifying can accommodate bus, crossbar switch, and memory latencies that can occur during run time. In embodiments, the modifying can be performed by hardware. The hardware can include a compute element, a modifying element within the array, a modifying element associated with the array, etc. The need to modify the tag can result from execution of an operation. In embodiments, the hardware modifying is based on a change of memory access hazards. An example of when such a change can occur is a branch decision. The branch decision determines which side of the branch to take, and which side or sides not to take. As a result, any memory access operations initiated by operations associated with the untaken side or side are terminated, thereby changing memory access hazards. Memory access operations to various types of memories can also change memory access hazards. In embodiments, the change of memory access hazards can result from a long access data load. A long access data load can result from accessing a memory such as a DRAM, a non-volatile memory, and so on.

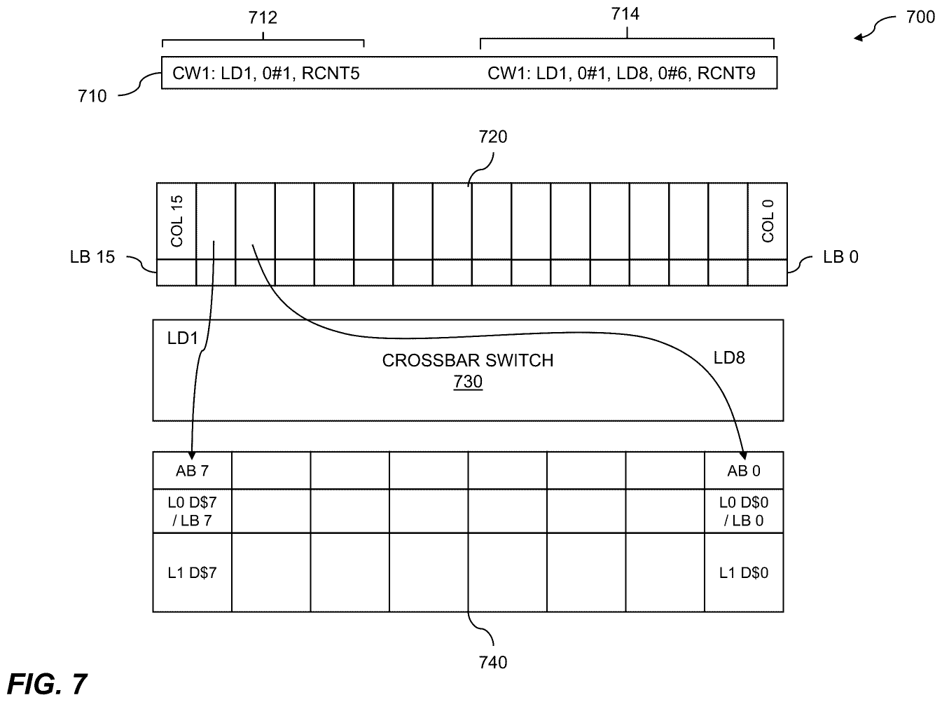

FIG. 7 shows a control word with load operations 700. Tasks, subtasks, and so on comprise operations. The operations can include memory access operations such as load and store operations; arithmetic operations such as multiplication, division, addition, and subtraction; logical operations such as AND, NAND, OR, NOR XOR, XNOR; and so on. The operations can be included in control words generated by a compiler. While some of the operations must be executed sequentially due to data dependencies, other operations can be executed in parallel. Thus, overall number of operations can be reduced by combining subsets of operations that can be executed in parallel into a reduced number of control words. This combining of operations into a reduced number of control words can be accomplished by the compiler. A control word can include one or more of a load, an operation, a store, and so on. A control word with store operations is enabled by parallel processing hazard mitigation avoidance. An array of compute elements is accessed, wherein each compute element within the array of compute elements is known to a compiler and is coupled to its neighboring compute elements within the array of compute elements. Control for the compute elements is provided on a cycle-by-cycle basis, wherein control is enabled by a stream of wide control words generated by the compiler. Memory access operation hazard mitigation is enabled, wherein the hazard mitigation is enabled by a control word tag, wherein the control word tag supports memory access precedence information and is provided by the compiler at compile time. A hazardless memory access operation is executed, wherein the hazardless memory access operation is determined by the compiler, and wherein the hazardless memory access operation is designated by a unique set of precedence information contained in the tag.

An example control word with load operations is shown 710. The control word can combine two or more load operations from a sequence of operations, where the sequence of operations can include one or more of loads, stores, data operations, and so on. The first operation in the original sequence 712 can be combined 714 with a later operation. In embodiments, the later operation can be combined with the first operation in order to issue an early load. The early load can enable loading data prior to when the data associated with the load is required by an operation, when the early load accesses a different area of storage, and the like. The later operation can be executed in parallel with the first operation since the later operation does not require data that can be operated on by or shortly after the first operation. The control word comprises one or more operations such as LD1 and LD8. The control word can further include a memory operation number, where the memory operation number can designate a semantic order for the operations. The control word can further include a return count. The return count can include a count of a number of compiler, or architectural, cycles that can elapse before the load data is taken up by the array. In the example, the return count for LD1 is excluded because the operation is to be executed immediately. The return count for LD2, RCNT9, indicates that nine cycles can elapse before the load data must be returned, and that the LD2 has lower precedence than LD1.

The control word, CW1, can be executed on the array. In order to perform the load operation, The load operation involves load buffers 720 associated with the array, although ideally the load buffers are never actually used in the sense that load data arrives just in time and is directly placed on the column data bus at the bottom (or top) of the array. However, a load buffer slot is dynamically allocated by the hardware for every load in flight in case a load returns earlier than expected. The load buffers can be organized in columns and can be addressed by load buffer zero LB0 to load buffer fifteen LB15. An address associated with each load request transits a crossbar switch 730 to an access buffer 740. For simplicity, the transit time through the crossbar switch can be assumed initially to be one wall clock cycle. That is, there are no crossbar conflicts that can result in additional delays. The access buffer can include an access buffer within a plurality of access buffers. The plurality of access buffers can include access buffer zero AB0 through access buffer seven AB7. Each access buffer within the plurality of access buffers can be coupled to a level zero data cache such as level zero data cache zero L0 D$0 through level zero data cache seven L0 D$7. Each level zero data cache can also be designated a line buffer such as line buffer zero LB0 through line buffer seven LB7. Each level zero data cache can be coupled to a level 1 data cache such as level 1 data cache zero L1 D$0 through level 1 data cache 7 L1 D$7. For the LD1 operation, the address associated with LD1 flows through or transits the crossbar switch to access buffer seven AB7. For the LD8 operation, the address associated with LD8 flows through the crossbar switch to access buffer zero AB0. In the figure, the source load buffers and the target access buffers are arbitrarily selected.

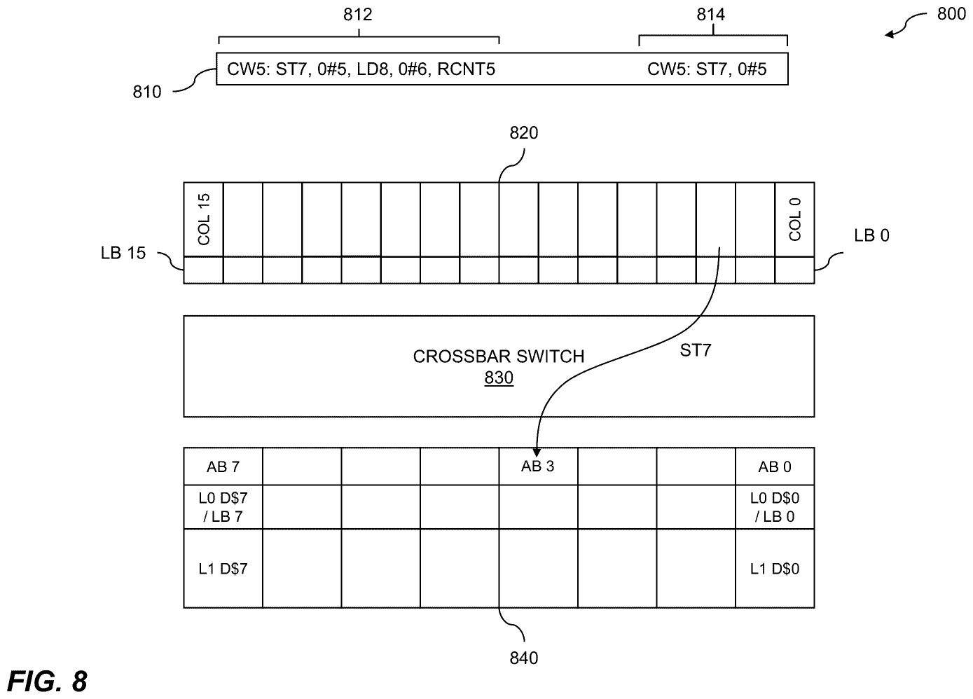

FIG. 8 illustrates a control word with a store operation 800. As stated above, a control word can include one or more operations, where the operations can include load, store, arithmetic, logical, and other operations. The control word further includes a tag, provided by the compiler, where the control word tag supports memory access precedence information. The control word and tag, generated by the compiler, can be associated with tasks, subtasks, and so on. The store operation can be used to store data generated by a compute element within an array of compute elements. The store operation can transfer data to an access buffer associated with a memory, where the memory can include a single-level or multi-level cache, a memory system, and the like. The control word with a store operation is enabled by parallel processing hazard mitigation avoidance. An example control word with store operations is shown 810. The control word, control word five CW5, can include one or more operations, where the one or more operations are associated with a sequence of operations. Recall that more than one operation can be included into a control word to enable parallel execution of operations on the array. By extension, control words can be simplified. The simplification can result when one or more of the operations that can normally follow in the original sequence of operations and can be parallelized, such as in control word 812, have already been executed. The result of the simplification can be seen in control word 814. The control word 814 comprises a single operation such as ST7. The control word can further include a memory operation number and a return count. In the example, the operation count is five O #5. The return count is omitted in this example since the control word and the operation number are the same.

The control word, CW5, can be executed on the array. The control word, which can be executed in a compute element within the array, can initiate a store operation. However, two compute elements can also cooperate to generate a store-one to supply the data and another to supply the address. The store operation involves load buffers 820 associated with the array. The load buffers can be organized in columns and can be addressed by load buffer zero LB0 to load buffer fifteen LB15. As for the load example discussed previously, an address associated with the store request transits a crossbar switch 830 to an access buffer within a plurality of access buffers 840. For simplicity, the transit time through the crossbar switch can be assumed initially to be one wall clock cycle, where no crossbar conflicts can occur to result in additional delays. The plurality of access buffers can include access buffer zero AB0 through access buffer seven AB7. Each access buffer within the plurality of access buffers can be coupled to a level zero data cache such as level zero data cache zero L0 D$0 through level zero data cache seven L0 D$7. Each level zero data cache can also be designated a line buffer such as line buffer zero LB0 through line buffer seven LB7. Each level zero data cache can be coupled to a level 1 data cache such as level 1 data cache zero L1 D$0 through level 1 data cache 7 L1 D$7. For the ST7 operation, the address associated with ST7 transits the crossbar switch to access buffer three AB3.

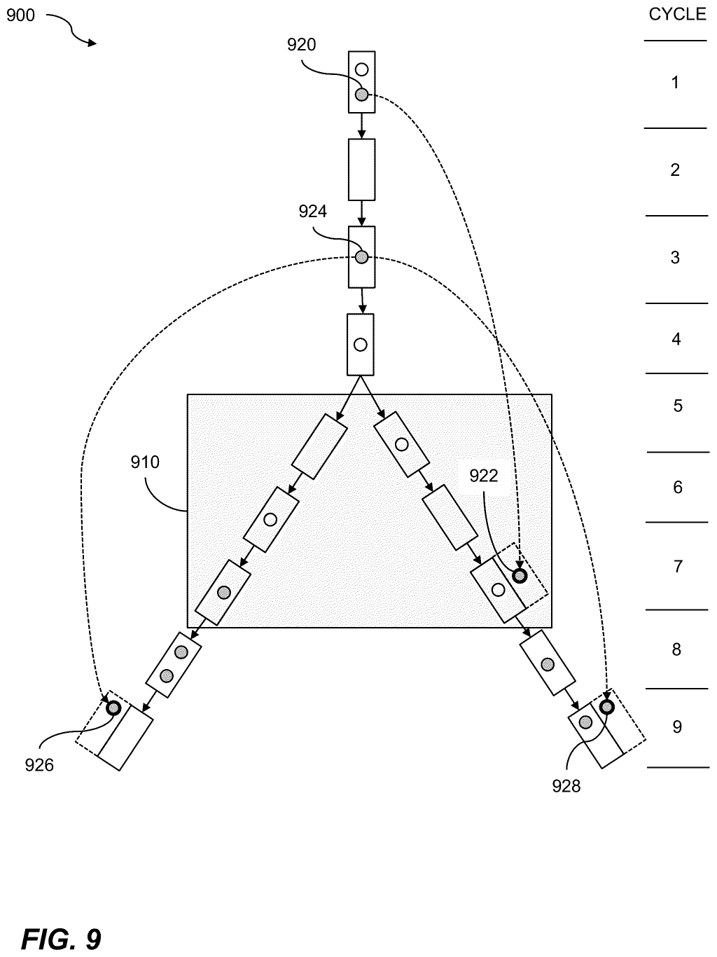

FIG. 9 shows branch handling for hazard mitigation avoidance. Branches can occur within processes, tasks, and subtasks that can be executed on compute elements within an array. The branch operations are based on decisions that are determined within code that implements the processes, tasks, subtasks, etc. The branches can be based on one or more logical operations such as AND, NAND, OR, NOR, XOR, XNOR operations, shift and rotate operations, and so on. The branches can be based on one or more arithmetic operations such as addition, subtraction, multiplication, division, etc. The branches can cause a context switch. To speed execution of branches when a branch decision is determined, operations and data associated with multiple branch paths that pertain to the branch decision can be fetched prior to the branch decision being determined. Further, execution of the operations associated with each branch path can begin prior to the branch decision being made. When the branch decision is made, execution can continue for operations associated with the taken path, while the operations associated with one or more untaken paths can be halted.

The handling of branch paths and branch decisions can be complex because accessing data prior to the branch decision being determined can be rife with memory access hazards. The memory access hazards, which can include load (read) hazards and store (write) hazards, can include write-after-read conflicts, read-after-write conflicts, write-after-write conflicts, etc. The branch handling can be accomplished based on parallel processing hazard mitigation avoidance. An array of compute elements is accessed, wherein each compute element within the array of compute elements is known to a compiler and is coupled to its neighboring compute elements within the array of compute elements. Control is provided for the compute elements on a cycle-by-cycle basis, wherein control is enabled by a stream of wide control words generated by the compiler. Memory access operation hazard mitigation is enabled, wherein the hazard mitigation is enabled by a control word tag, wherein the control word tag supports memory access precedence information and is provided by the compiler at compile time. A hazardless memory access operation is executed, wherein the hazardless memory access operation is determined by the compiler, and wherein the hazardless memory access operation is designated by a unique set of precedence information contained in the tag.

The figure shows branch handling including hazard detection and mitigation. The hazard mitigation is based on hazard mitigation avoidance 900. Recall that a hazard can occur when valid data is not available for loading when a compute element requires the data, when valid data is overwritten by store data before the valid data can be loaded or stored, and so on. Such hazards can be identified by comparing load and store addresses of memory access operations requested by compute element operations. In embodiments, the pending data cache accesses can be examined in the access buffer. Recall that memory access data can be held prior to promotion (e.g., storing into memory, loading into compute elements, holding in a buffer, etc.). As a result, data associated with memory access operations may still be located within buffers such as access buffers. Embodiments can include identifying hazardous loads and stores by comparing load and store addresses to contents of an access buffer. The comparing can be accomplished by comparing contents of the access buffer, and comparing addresses within the access buffer, among other techniques. In embodiments, the comparing can examine addresses and identify potential accesses to the same address.

In embodiments, memory access operation hazard mitigation is enabled by a control word tag, where the control word tag supports memory access precedence information and is provided by the compiler at compile time. Since the compiler cannot know a priori at compile time, in embodiments, the tag can be modified during runtime. The modifying can be required based on data transit times across the crossbar switch, memory access times for load requests and store requests that occur at a given time due to task or subtask execution, and the like. In embodiments, the modifying can be performed by hardware. The hardware can include one or more compute elements within the array, other hardware associated with the array, etc. In embodiments, the hardware modifying can be based on a change of memory access hazards. Additional information such as precedence information can be used to tag memory access operations. Further embodiments comprise including the precedence information in the comparing. The precedence information can provide further insight into identifying hazards by indicating an order of memory access operations, timing information such as a cycle or relative cycle in which a memory access operation takes place, etc.

Various techniques can be used for examining the contents of the access buffers for load and store hazards. The examining can include a store probe. In embodiments, the examining can include interrogating the access buffer for pending load or store addresses. Logic can be associated with the access buffer which can include logic to determine address matches between pending memory access loads and stores and addresses associated with memory access loads and stores within the access buffer. In embodiments, the interrogating compares a store probe address to the pending load or store addresses. The store probe address can be provided by a memory access requested generated by a compute element. Further embodiments can include identifying hazardous loads and stores by comparing load and store addresses to addresses of contents of the access buffer. The store probe address can be compared to pending load or store addresses already within the access buffer. In embodiments, the comparing can identify potential accesses to the same address. Potential accesses to the same address can cause one or more memory access hazards, depending on the order in which the accesses are performed. Discussed previously, further embodiments can comprise including precedence information in the comparison. The precedence information can be based on execution precedence, execution order, priority, and so on. The precedence information can be used to allow or disallow committing data to the data cache. Further embodiments include delaying the promoting of data to the access buffer and/or releasing data from the access buffer. The delaying can be based on a number of cycles such as architectural cycles, completion of another operation, and the like. In embodiments, the delaying can avoid hazards. Further techniques can be used to avoid hazards. In other embodiments, the avoiding hazards can be based on a comparative precedence value.

Returning to the modification of a tag during runtime, in embodiments, the hardware modifying can be based on a change of memory access hazards. The change of memory access hazards can result from the completion of memory access operations, completion of tasks or subtasks executing on the array of compute elements, and the like. In other embodiments, the change of memory access hazards can result from a branch operation decision. The branch operation decision can be associated with a task, a subtask, etc. In a usage example, a branch operation is encountered with in a task. Load and memory access operations associated with each side of the branch operation can be performed pending the branch decision being determined. When the branch decision is determined, execution of operations associated with the taken side of the branch can proceed, while operations associated with the untaken side of the branch can be halted, flushed, etc. The load operations associated with the untaken side are discontinued, thus changing possible memory access hazards. In further embodiments, the change of memory access hazards can result from a long access data load. A long access data load can result when a requested data causes a cache miss. The cache miss can include a cache miss associated with a single level cache, a multilevel cache, etc. The cache miss can cause the data load operation to reach out to a memory system, resulting in longer load times. The load time can further be dependent upon the type of memory associated with the memory system. In embodiments, the long access data load can include a memory access from dynamic random-access memory (DRAM). Accessing a DRAM as opposed to accessing a static random-access memory (SRAM) can result in a longer load time because of refresh and other access overhead associated with the DRAM. In other embodiments, the long access data load can include a memory access from non-volatile storage. The non-volatile storage can be used to store constants, coefficients, weights, etc. The non-volatile storage can be based on a variety of technologies. In embodiments, the non-volatile storage can include NAND flash storage.

In the figure, execution of compute element operations associated with control words provided on a cycle-by-cycle basis is shown. The operations include a branch operation which can be used to decide between two branch paths, a left side path and a right-side path. Discussed previously, the identifying memory access load and store hazards can enable hazard mitigation. In the example 900, speculative encoding within code words of both branch paths can enable “prefetching” of compute element operations and data manipulated by the operation. The prefetching can include loading data manipulated by operations associated with both paths. A branch shadow 910 can include a number of cycles during which operations associated with each branch path can be executed prior to the branch decision. In the example, the branch shadow can occur during cycles 5, 6, and 7. The branch shadow can correspond to execution of operations associated with cycles 2, 3, and 4. During the branch shadow, loading data from buffers such as access buffers cannot be allowed because the data in the access buffers may be updated during the cycles prior to the branch operation. As a result, the hazard mitigation techniques described before, namely hazard mitigation accomplished by load-to-store forwarding, store-to-load forwarding, and store-to-store forwarding, cannot be allowed. To ameliorate this problem, stores from the untaken branch path can be suppressed from departing the array. By suppressing the stores from the untaken branch path from departing the array, crossbar resources and access buffer resources can be preserved.

Returning to the figure, a compiled code snippet comprising nine control words includes a branch decision at control word 4. Each cycle can include a data load operation, a data processing operation, data store operations, and so on. In the figure, an open circle represents a store address and store data emerging from the array of compute elements; a filled circle represents a load address emerging from the array; and the bold, filled circle represents a scheduled load data pickup by the array. In the example, load and store access operations that emanate from the compute element array are not suppressed in the access buffers for branch paths not taken during the branch shadow 910. The “not suppressing” load operations and store operations can maximize throughput and minimize latency of a crossbar switch coupled between the compute element array and the access buffers. A precedence tag associated with cycle 1 920 can indicate cycle 7 922, the cycle during which the load data is taken up by the array for processing. Similarly, a precedence tag associated with cycle 3 924 can indicate left-hand branch path cycle 9 926 and its branch analog, right-hand branch path cycle 9 928. Cycle 9 is the cycle during which the load data, indicated with cycle 3, is taken up by the array for processing. If the branch decision in cycle 4 indicates to proceed down the right-hand side branch (e.g., the taken path), then the load in cycle 6 and the store in cycle 7 of the left-hand side branch (e.g., the not taken path) can be suppressed or ignored prior to entry to the crossbar switch. The two store operations in cycle 8 of the left-hand side branch are not executed because the code illustrated in the code snippet has branched away from this the left-hand branch within the array.

The store memory access store operations associated with cycles 1, 4, and 5 can be aliased into the load operation issued in cycle 1 920 to ameliorate a read-after-write hazard associated with the right-hand path. The store operations associated with cycles 4, 5, and 7 can be aliased into the load operation issued in cycle 3 924 to ameliorate a read-after-write hazard associated with the right-hand path. The store operations associated with cycles 4 and 6 can alias into the load operation issued in cycle 3 to ameliorate a read-after-write hazard associated with the left-hand path. The store operation associated with cycle 8 can be aliased to the other store operation associated with cycle 8 to ameliorate a write-after-write hazard for the left-hand path.

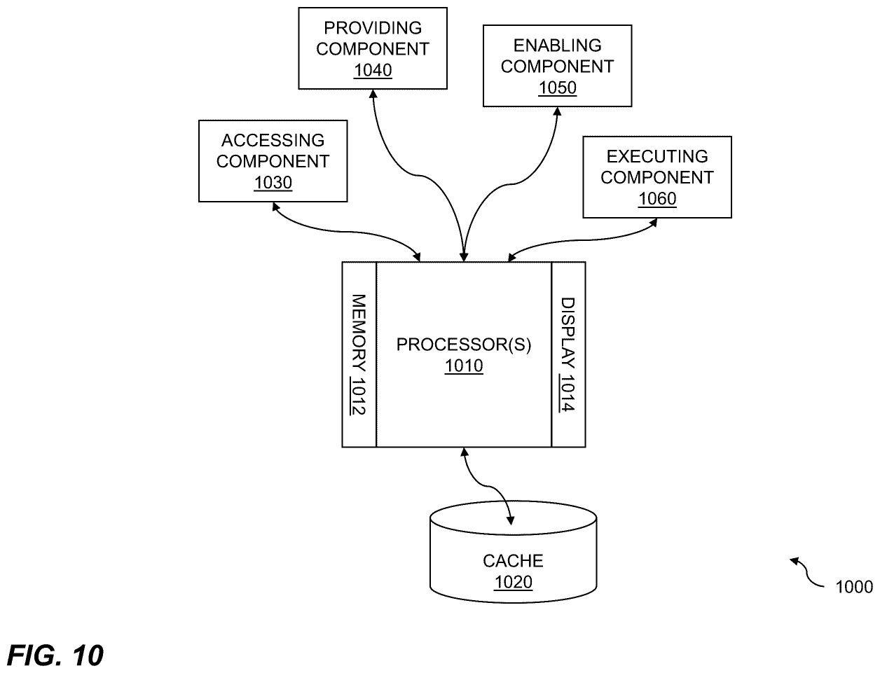

FIG. 10 is a system diagram for parallel processing. The parallel processing is enabled by parallel processing hazard mitigation avoidance. The system 1000 can include one or more processors 1010, which are coupled to a memory 1012 which stores instructions. The system 1000 can further include a display 1014 coupled to the one or more processors 1010 for displaying data; intermediate steps; directions; control words; control word tags; control word bunches; compressed control words; control words implementing Very Long Instruction Word (VLIW) functionality; topologies including systolic, vector, cyclic, spatial, streaming, or VLIW topologies; and so on. In embodiments, one or more processors 1010 are coupled to the memory 1012, wherein the one or more processors, when executing the instructions which are stored, are configured to: access an array of compute elements, wherein each compute element within the array of compute elements is known to a compiler and is coupled to its neighboring compute elements within the array of compute elements; provide control for the compute elements on a cycle-by-cycle basis, wherein control is enabled by a stream of wide control words generated by the compiler; enable memory access operation hazard mitigation, wherein the hazard mitigation is enabled by a control word tag, wherein the control word tag supports memory access precedence information and is provided by the compiler at compile time; and execute a hazardless memory access operation, wherein the hazardless memory access operation is determined by the compiler, and wherein the hazardless memory access operation is designated by a unique set of precedence information contained in the tag. The compute elements can include compute elements within one or more integrated circuits or chips; compute elements or cores configured within one or more programmable chips such as application specific integrated circuits (ASICs); field programmable gate arrays (FPGAs); heterogeneous processors configured as a mesh; standalone processors; etc.

The system 1000 can include a cache 1020. The cache 1020 can be used to store data such as scratchpad data, operations that support a balanced number of execution cycles for a data-dependent branch; directions to compute elements, control words, control word tags, and control word bunches comprising control word bits; intermediate results; microcode; branch decisions; and so on. The cache can comprise a small, local, easily accessible memory available to one or more compute elements. In embodiments, the data that is stored can include operations, additional operations, and so on, where the operations and additional operations are contained in one or more control words and can be loaded into one or more autonomous operation buffers. The operations, additional operations, and the like can enable autonomous compute element operations using buffers. The data within the cache can include data required to support dataflow processing by statically scheduled compute elements within the 2D array of compute elements. The cache can be accessed by one or more compute elements. The cache, if present, can include a dual read, single write (2R1W) cache. That is, the 2R1W cache can enable two read operations and one write operation contemporaneously without the read and write operations interfering with one another.

The system 1000 can include an accessing component 1030. The accessing component 1030 can include control logic and functions for accessing an array of compute elements. The array of compute elements can include a two-dimensional (2D) array and three-dimensional (3D) arrays. The array of compute elements can comprise a plurality of compute element arrays. Each compute element within the array of compute elements is known to a compiler and is coupled to its neighboring compute elements within the array of compute elements. A compute element can include one or more processors, processor cores, processor macros, processor cells, and so on. Each compute element can include an amount of local storage. The local storage may be accessible by one or more compute elements. Each compute element can communicate with neighbors, where the neighbors can include nearest neighbors or more remote “neighbors”. Communication between and among compute elements can be accomplished using a bus such as an industry standard bus, a ring bus, a network such as a wired or wireless computer network, etc. In embodiments, the ring bus is implemented as a distributed multiplexor (MUX).

The system 1000 can include a providing component 1040. The providing component 1040 can include control and functions for providing control for compute elements on a cycle-by-cycle basis, wherein control is enabled by a stream of wide control words generated by the compiler. The control words can be based on low-level control words such as assembly language words, microcode words, and so on. The control word can include control word bunches. In embodiments, the control word bunches can provide operational control of a particular compute element. The control of the compute elements on a cycle-by-cycle basis can include configuring the array to perform various compute operations. In embodiments, the stream of wide control words generated by the compiler provides direct, fine-grained control of the 2D array of compute elements. The compute operations can enable audio or video processing, artificial intelligence processing, machine learning, deep learning, and the like. The providing control can be based on microcode control words, where the microcode control words can include opcode fields, data fields, compute array configuration fields, etc. The compiler that generates the control can include a general-purpose compiler, a parallelizing compiler, a compiler optimized for the array of compute elements, a compiler specialized to perform one or more processing tasks, and so on. The providing control can implement one or more topologies such as processing topologies within the array of compute elements. In embodiments, the topologies implemented within the array of compute elements can include a systolic, a vector, a cyclic, a spatial, a streaming, or a Very Long Instruction Word (VLIW) topology. Other topologies can include a neural network topology. A control can enable machine learning functionality for the neural network topology.

The system block diagram 1000 can include an enabling component 1050. The enabling component 1050 can include control and functions for enabling memory access operation hazard mitigation, wherein the hazard mitigation is enabled by a control word tag, wherein the control word tag supports memory access precedence information and is provided by the compiler at compile time. The tag can further include priority information. In embodiments, the precedence information can enable correct hardware ordering of loads and stores. The correct ordering of load operations and store operations can be based on a sequence of operations, an order of tasks and subtasks, etc. In embodiments, the loads and stores can include memory access loads to the array of compute elements and memory access stores from the array of compute elements. The precedence information can apply to orders of operations such as arithmetic operations (e.g., multiplication, division, addition, and subtraction or MDAS) and so on. That is, in embodiments, the precedence information can provide semantically correct operation ordering. In a usage example, consider the simple equation D=A+B*C. The load operations associated with variables B and C can have a higher priority than the load operation associated with variable A since the multiplication of B and C occurs prior to adding their product to A. Further, storing D occurs after the multiplication and addition operations.

In further embodiments, the unique precedence information contained in the tag can include a unique tag field. The unique tag field can include a fixed number of bits or bytes, a variable number of bits or bytes, etc. In embodiments, the unique tag field can support multiple control word memory accesses. A control word can include one or more load or store operations, in which each load and store operation can include a memory address, a target address such as a compute element requesting data, and so on. The control word can include an “early” load, where an early load can request load data associated with a later operation. In other embodiments, the unique tag field indicates safe/unsafe memory access. A safe memory access can include loading a constant value. An unsafe memory access can include memory accesses that must be properly ordered so as to maintain data integrity. In further embodiments, the unique precedence information can include an illegal precedence value. An illegal precedence value can indicate that the control word is not to be executed. In a usage example, an illegal precedence value can be used to indicate an untaken side of a branch.

The system 1000 can include an executing component 1060. The executing component 1060 can include control and functions for executing a hazardless memory access operation, wherein the hazardless memory access operation is determined by the compiler, and wherein the hazardless memory access operation is designated by a unique set of precedence information contained in the tag. The precedence information contained in the tag can provide an order for performing loads, stores, operations, and so on. As stated previously, in embodiments, the precedence information can provide semantically correct operation ordering. Recall that the precedence information is provided by the compiler at compile time. However, the compiler cannot know a priori what possible memory access latencies, or crossbar transit time latencies, may be encountered by load operations and store operations during runtime. Further embodiments can include modifying the tag during runtime. The modifying the tag can consider various latencies that can occur at runtime, such as bus latencies, crossbar switch latencies, memory system load and store latencies, etc. In embodiments, the modifying can be performed by hardware. The hardware that can modify the tag can include a compute element, hardware associated with the array of compute elements, hardware coupled to the array, and so on. In embodiments, the hardware modifying can be based on a change of memory access hazards. The memory access hazards can change based on execution of an operation. In embodiments, the change of memory access hazards can result from a branch operation decision. Since one side of a branch is taken based on the branch decision, and one or more other sides of the branch are not taken, load and store operations associated with an untaken side or sides of the branch are terminated, thereby changing the memory access hazards.

In other embodiments, the change of memory access hazards can result from a long access data load. Latency associated with a memory access load operation can be dependent on where the data requested by the load operation can be obtained. Ideally, based on the locality of data, the load operation can be accomplished by accessing an address within a cache memory such as a data cache. The data cache can include a single-level cache, a multi-level cache, and so on. If the load address is not located within the cache memory, then a cache miss occurs, and the load operation accesses a memory system. The memory system can comprise various types of memories, where each memory type can include an access time. The access times associated with some memory types are longer than access times associated with other memory types. In embodiments, the long access data load can include a memory access from dynamic random-access memory (DRAM). While the access time associated with a DRAM can be longer than the access time associated with a different memory type such as a static random-access memory, (SRAM), the DRAM data density can be much denser than that of the SRAM, making the DRAM preferable to SRAM in some memory system applications. In other embodiments, the long access data load can include a memory access from non-volatile storage. The non-volatile storage can be used for a variety of applications such as storage of constants, coefficients, weights, etc.

The hazardless memory access operations can load data required by a variety of operations. The operations that can be performed on compute elements within the array can include arithmetic operations, Boolean operations, matrix operations, neural network operations, and the like. The operations can be executed based on the control words generated by the compiler. The control words can be provided to a control unit, where the control unit can control the operations of the compute elements within the array of compute elements. Operation of the compute elements can include configuring the compute elements, providing data to the compute elements, routing and ordering results from the compute elements, and so on. Embodiments further include generating a task completion signal. The task completion signal can include a flag, a semaphore, a message, and so on. In embodiments, the task completion signal can be based on a value in the compute element operation counter. The additional operations can also be executed. Embodiments further include executing the additional operations cooperatively among the subset of compute elements. The additional operations can include parallel operations. In embodiments, the additional operations can complete autonomously from direct compiler control. The autonomous completion of the additional operations can reduce a number of compiler instructions, free the compiler from having to keep track of detailed memory access timing issues, and so on.

The same control operations associated with control words can be executed on a given cycle across the array. The operations can provide control on a per compute element basis, where each control word can be comprised of a plurality of compute element control groups, clusters, and so on. In embodiments, a control unit can operate on compute element operations. The executing operations can include distributed execution of operations. In embodiments, the distributed execution of operations can occur in two or more compute elements within the array of compute elements. The executing operations can include storage access, where the storage can include a scratchpad memory, one or more caches, register files, etc., within the 2D array of compute elements. Further embodiments include a memory operation outside of the array of compute elements. The “outside” memory operation can include access to a memory such as a high-speed memory, a shared memory, a remote memory, etc. In embodiments, the memory operation can be enabled by autonomous compute element operation. As for other control associated with the array of compute elements, the autonomous compute element operation is controlled by the operations and the additional operations. In a usage example, operations and additional operations can be loaded into buffers to control operation of one or more compute elements. Data to be operated on by the compute element operations can be loaded. Data operations can be performed by the compute elements without loading further control word bunches for a number of cycles. The autonomous compute element operation can be based on operation looping. In embodiments, the operation looping can accomplish dataflow processing within statically scheduled compute elements. Dataflow processing can include processing based on the presence or absence of data. The dataflow processing can be performed without requiring access to external storage.

The operation that is being executed can include a data dependent branch operation. The branch operation can include two or more branches, where a branch is selected based on an operation such as an arithmetic or logical operation. In a usage example, a branch operation can determine the outcome of an expression such as A>B. If A is greater than B, then one branch can be taken. If A is less than or equal to B, then another branch can be taken.

In embodiments, the compiler can calculate a latency for the data dependent branch operation. Since execution of the at least two operations is impacted by latency, the latency can be scheduled into compute element operations. In order to further speed execution of a branch operation, sides of the branch can be precomputed prior to datum A and datum B being available. When the data is available, the expression can be computed (which is a form of predication), and the proper branch direction can be chosen. The untaken branch data and operations can be discarded, flushed, etc. In embodiments, the two or more data dependent branch operations can require a balanced number of execution cycles. The balanced number of execution cycles can reduce or eliminate idle cycles, stalling, and the like. In embodiments, the balanced number of execution cycles is determined by the compiler. In embodiments, the accessing, the providing, the loading, and the executing enable background memory accesses. The background memory access enables a control element to access memory independently of other compute elements, a controller, etc. In embodiments, the background memory accesses can reduce load latency. Load latency is reduced since a compute element can access memory before the compute element exhausts the data that the compute element is processing.

The system 1000 can include a computer program product embodied in a non-transitory computer readable medium for parallel processing, the computer program product comprising code which causes one or more processors to perform operations of: accessing an array of compute elements, wherein each compute element within the array of compute elements is known to a compiler and is coupled to its neighboring compute elements within the array of compute elements; providing control for the compute elements on a cycle-by-cycle basis, wherein control is enabled by a stream of wide control words generated by the compiler; enabling memory access operation hazard mitigation, wherein the hazard mitigation is enabled by a control word tag, wherein the control word tag supports memory access precedence information and is provided by the compiler at compile time; and executing a hazardless memory access operation, wherein the hazardless memory access operation is determined by the compiler, and wherein the hazardless memory access operation is designated by a unique set of precedence information contained in the tag.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams show functions, steps, or groups of steps of the methods, apparatus, systems, computer program products and/or computer-implemented methods. Any and all such functions generally referred to herein as a “circuit,” “module,” or “system” may be implemented by computer program instructions, by special-purpose hardware-based computer systems, by combinations of special purpose hardware and computer instructions, by combinations of general-purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM); an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States, then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for parallel processing comprising:
accessing an array of compute elements, wherein each compute element within the array of compute elements is known to a compiler and is coupled to its neighboring compute elements within the array of compute elements;
providing control for the compute elements on a cycle-by-cycle basis, wherein control is enabled by a stream of wide control words generated by the compiler;
enabling memory access operation hazard mitigation, wherein the hazard mitigation is enabled by a control word tag, wherein the control word tag supports memory access precedence information and is provided by the compiler at compile time; and
executing a hazardless memory access operation, wherein the hazardless memory access operation is determined by the compiler, and wherein the hazardless memory access operation is designated by a unique set of precedence information contained in the tag.

2. The method of claim 1 further comprising modifying the tag during runtime.

3. The method of claim 2 wherein the modifying is performed by hardware.

4. The method of claim 3 wherein the hardware modifying is based on a change of memory access hazards.

5. The method of claim 4 wherein the change of memory access hazards results from a branch operation decision.

6. The method of claim 4 wherein the change of memory access hazards results from a long access data load.

7. The method of claim 6 wherein the long access data load comprises a memory access from dynamic random-access memory (DRAM).

8. The method of claim 6 wherein the long access data load comprises a memory access from non-volatile storage.

9. The method of claim 8 wherein the non-volatile storage comprises NAND flash storage.

10. The method of claim 2 wherein memory access precedence information provided by the compiler enables intra-control word precedence.

11. The method of claim 2 wherein the unique set of precedence information contained in the tag that was modified during runtime enables inter-control word precedence.

12. The method of claim 1 wherein the unique precedence information contained in the tag comprises a unique tag field.

13. The method of claim 12 wherein the unique tag field supports multiple control word memory accesses.

14. The method of claim 12 wherein the unique tag field indicates safe/unsafe memory access.

15. The method of claim 1 wherein the unique precedence information comprises an illegal precedence value.

16. The method of claim 1 wherein the hazardless memory access includes safe loads from a data cache.

17. The method of claim 16 wherein the safe load comprises a constant value.

18. The method of claim 16 wherein the safe load comprises a read probe.

19. The method of claim 1 wherein the hazardless memory access includes safe stores to a data cache.

20. The method of claim 19 wherein the safe store comprises a single compute element operation.

21. The method of claim 19 wherein the safe store comprises a store probe.

22. The method of claim 1 wherein the precedence information enables correct hardware ordering of loads and stores.

23. The method of claim 22 wherein the loads and stores comprise memory access loads to the array of compute elements and memory access stores from the array of compute elements.

24. The method of claim 23 wherein the precedence information provides semantically correct operation ordering.

25. A computer program product embodied in a non-transitory computer readable medium for parallel processing, the computer program product comprising code which causes one or more processors to perform operations of:
accessing an array of compute elements, wherein each compute element within the array of compute elements is known to a compiler and is coupled to its neighboring compute elements within the array of compute elements;
providing control for the compute elements on a cycle-by-cycle basis, wherein control is enabled by a stream of wide control words generated by the compiler;
enabling memory access operation hazard mitigation, wherein the hazard mitigation is enabled by a control word tag, wherein the control word tag supports memory access precedence information and is provided by the compiler at compile time; and
executing a hazardless memory access operation, wherein the hazardless memory access operation is determined by the compiler, and wherein the hazardless memory access operation is designated by a unique set of precedence information contained in the tag.

26. A computer system for parallel processing comprising:
a memory which stores instructions;
one or more processors coupled to the memory, wherein the one or more processors, when executing the instructions which are stored, are configured to:
access an array of compute elements, wherein each compute element within the array of compute elements is known to a compiler and is coupled to its neighboring compute elements within the array of compute elements;
provide control for the compute elements on a cycle-by-cycle basis, wherein control is enabled by a stream of wide control words generated by the compiler;
enable memory access operation hazard mitigation, wherein the hazard mitigation is enabled by a control word tag, wherein the control word tag supports memory access precedence information and is provided by the compiler at compile time; and
execute a hazardless memory access operation, wherein the hazardless memory access operation is determined by the compiler, and wherein the hazardless memory access operation is designated by a unique set of precedence information contained in the tag.
